(19) United States
(12) Patent Application Publication
(10) Pub. No.: US 2026/0180356 A1
(43) Pub. Date: Jun. 25, 2026

(54) METHOD FOR CHARGING AN ENERGY SUPPLY DEVICE AT DIFFERENT TEMPERATURES INCLUDING LOW TEMPERATURES, ENERGY SUPPLY DEVICE, AND CHARGING DEVICE FOR AN ENERGY SUPPLY DEVICE

(71) Applicant: ANDREAS STIHL AG & Co. KG, Waiblingen (DE)

(72) Inventors: Christian UHLMANN, Erlangen (DE); Daniel SAUERTEIG, Kernen (DE); Nicolai SARTORIUS, Stuttgart (DE); Jonas KLOSE, Esslingen (DE); Khushal VORA, Stuttgart (DE); Marvin SCHACHTA, Stuttgart (DE)

(73) Assignee: ANDREAS STIHL AG & Co. KG, Waiblingen (DE)

(21) Appl. No.: 19/423,096

(22) Filed: Dec. 17, 2025

(30) Foreign Application Priority Data
Dec. 20, 2024 (DE) 10 2024 139 469.2
Dec. 20, 2024 (DE) 10 2024 139 493.5

(51) Int. Cl. H02J 7/90; H01M 10/42; H01M 10/44; H01M 10/613; H01M 10/6235; H02J 7/40; H02J 7/50; H02J 7/82; H02J 7/84

(52) U.S. Cl. CPC H02J 7/977; H01M 10/443; H01M 10/613; H01M 10/6235; H02J 7/445; H02J 7/50; H02J 7/82; H02J 7/84; H02J 7/933; H01M 2010/4292

(57) ABSTRACT

The invention relates to a method for charging an energy supply device (1) for an electric tool (3) by means of a charging device (2) during a charging process, wherein the energy supply device (1) comprises a plurality of cell units (11, 12). The invention also relates to a charging device (2) for charging an energy supply device (1) for an electric tool (3) during a charging process, as well as an energy supply device (1) for an electric tool (3), which comprises a plurality of cell units (11, 12) and is configured for charging by means of a charging device (2) during a charging process.

### CROSS REFERENCE TO RELATED APPLICATIONS

This application, which claims priority under 35 U.S.C. § 119 of German Application No. DE 10 2024 139 469.2, filed on Dec. 20, 2024 and German Application No. DE 10 2024 139 493.5 filed on Dec. 20, 2024, the disclosures of which are incorporated by reference. The international application under PCT article 21(2) was not published in English.

### BACKGROUND OF THE INVENTION

A first embodiment of the present invention lies in the field of electrical energy supply technology and relates to a method for charging an energy supply device for an electric tool by means of a charging device during a charging process. The present invention also relates to a charging device for charging an energy supply device for an electric tool during a charging process, as well as an energy supply device for an electric tool, which is configured for charging by means of a charging device during a charging process.

To supply a mobile hand-guided and/or hand-held electric tool with electrical energy, an exchangeable and rechargeable energy supply device is typically used, which is also referred to as a “battery pack” or, in short, a “battery.”

In order to provide sufficient charging capacity for the energy supply device, the energy supply device typically comprises a plurality of cell units, also referred to as “battery cells” or, in short, “cells”. The cell units are combined into several modules and, depending on the configuration, are electrically connected to each other, for example in the form of a series connection and/or a parallel connection.

During a discharging process, cell units generate electrical energy through reversible electrochemical conversion processes in order to supply it to an electric tool in an operating state for driving the electric tool. One electrical storage technology frequently used in cell units is lithium-ion storage technology.

A separate charger, i.e., a charging device configured to supply electrical energy (charging energy) to the energy supply device, is typically used to charge the energy supply device.

In order to realize, in particular, a short charging time duration for an energy supply device, comparatively high charging currents with corresponding current strengths/voltages must be employed and/or comparatively high C-rates must be realized (so-called “fast charging”), which, however, means that several requirements must be met and various framework conditions must be observed, depending on the technology. The C-rates reach 15 to 20 C, in particular for short periods. The C-rates reach 1 C to 15 C for continuous charging currents, in particular 5 to 10 C, and especially 7 C. The power ranges of the charger for a processing device are between 100 W and 5 kW. At high charging powers, in particular attention must be paid to self-heating and the associated loss energy, as well as aging and the associated decrease in the performance of the energy supply device. Furthermore, at high charging powers with comparatively high current densities in the case of cell units based on lithium-ion storage technology, a plating of lithium ions can occur on the surface of the anodes of the cell units, which is referred to as “lithium plating” (abbreviated “Li-plating”). This results in a deposit of metallic lithium, which is also referred to as dendrite growth. Such lithium deposits can, for example, lead to a loss of capacity or a reduction in the lifetime of the energy supply device. Charging processes, and in particular fast charging processes, must therefore take these effects into account.

In a second embodiment, the invention lies in the field of electrical energy supply technology and relates a method for charging an energy supply device for an electric tool by means of a charging device during a charging process. The present invention also relates to a charging device for charging an energy supply device for an electric tool during a charging process, as well as an energy supply device for an electric tool, which is configured for charging by means of a charging device during a charging process.

To supply a mobile hand-guided and/or hand-held electric tool with electrical energy, an exchangeable and rechargeable energy supply device is typically used, which is also referred to as a “battery pack” or, in short, a “battery.”

In order to provide sufficient charging capacity for the energy supply device, the energy supply device typically comprises a plurality of cell units, also referred to as “battery cells” or, in short, “cells”. The cell units are combined into several modules and, depending on the configuration, are electrically connected to each other, for example in the form of a series connection and/or a parallel connection.

During a discharging process, cell units generate electrical energy through reversible electrochemical conversion processes in order to supply it to an electric tool in an operating state for driving the electric tool. During a discharging process, heat is also generated, which is accompanied by an increase in temperature. One electrical storage technology frequently used in cell units is lithium-ion storage technology.

A separate charger, i.e., a charging device configured to supply electrical energy (charging energy) to the energy supply device, is typically used to charge the energy supply device.

In order to realize, in particular, a shorter charging time duration for an energy supply device, comparatively high charging currents with corresponding current strengths/voltages must be employed and/or comparatively high C-rates must be realized (so-called “fast charging”), which, however, means that several requirements must be met and various framework conditions must be observed, depending on the technology. The C-rates reach 15 to 20 C, in particular for short periods. The C-rates reach 1 C to 15 C for continuous charging currents, in particular 5 to 10 C, and especially 7 C. The power ranges of the charger for a processing device are between 100 W and 5 kW.

One challenge in this context is charging the energy supply device at comparatively deep (low) temperatures, because the electrochemical conversion processes are temperature-dependent, among other things. A comparatively deep (low) temperature of the energy supply device can be, for example, around 0 degrees Celsius or below 0 degrees Celsius. Deep (low) temperatures lead, for example, to reduced ion mobility, increased internal resistance, and/or plating of the reaction material on the anode, for example in the form of the so-called lithium plating in an energy supply device based on lithium-ion storage technology.

### SUMMARY OF THE INVENTION

In a first embodiment, it is an object of the present invention to provide a method for charging an energy supply device, in particular a hand-held, manually tool-free mountable and demountable and/or exchangeable energy supply device, for an electric tool by means of a charging device during a charging process, wherein the method is characterized in particular with respect to the energy supply device by a reduced charging time duration, reduced loss energy, and/or reduced aging. Furthermore, it is an object of the present invention to provide a charging device and an energy supply device, each of which is configured to carry out the method according to the present invention. In addition, it is an object of the present invention to provide a system with at least one energy supply device and a charging device, as well as a computer program product for carrying out the method according to the present invention.

The object is solved by the features of claims 1, 8, 9 and 10. Further embodiments and applications of the present invention are apparent from the dependent claims and are explained in more detail in the following description with partial reference to the figures.

The present invention relates, from a general point of view, to a method for charging an energy supply device for an electric tool by means of a charging device during a charging process, wherein the energy supply device comprises a plurality of cell units, with the method steps: a) determining at least one heat information associated with the energy supply device, in particular at least one cell unit, and/or the charging device; b) determining at least one deposition information associated with a reaction material at an anode of at least one of the cell units; c) supplying a first defined charging current to the energy supply device, in particular to the at least one cell unit; d) adjusting, in particular controlling and/or regulating, the first defined charging current to a second defined charging current until • at least one first evaluation criterion, which comprises at least one thermal condition, is fulfilled by the at least one heat information in order to set, essentially maintain and/or not exceed a defined temperature in the energy supply device, in particular in the at least one cell unit; and/or • at least one second evaluation criterion, which comprises at least one electrochemical condition, is fulfilled by the at least one deposition information in order to essentially avoid or at least limit, in a defined manner, a deposition, in particular a plating, of the reaction material at the anode of the at least one cell unit.

The present invention provides a method for charging (charging method) for an energy supply device, by means of which a charging time duration for the charging process can be optimized, in particular shortened, without, however, significantly affecting aging and the associated lifetime of the energy supply device. In particular, aging effects can be significantly reduced. Furthermore, deposition effects of a reaction material, for example in the form of lithium, can be essentially avoided or at least limited in a defined manner.

The method according to the present invention takes into account at least one heat information and/or at least one deposition information in order to adjust the charging current. The at least one heat information can comprise a temperature, a temperature curve, a temporal change in a temperature curve, and/or a rate of change in a temperature curve at a defined point in time and/or from a defined point in time. The temperature can be associated with the energy supply device and/or the charging device and/or an environment in which the energy supply device is located. The temperature can comprise a cell temperature of at least one cell unit, a cooling air temperature of the charging device, an ambient temperature of the charging device, and/or an ambient temperature of the energy supply device. In other words, the at least one heat information can comprise a self-heating of the energy supply device before and/or during the charging process. In addition or alternatively, the at least one heat information can comprise a cooling behaviour of the charging device, in particular during the charging process. The at least one heat information can comprise a cooling behaviour of the charging device in the form of cooling and/or warming up before the charging process, at the start of the charging process, after the start of the charging process, and/or after an interruption duration of the charging process.

The at least one heat information can in particular comprise a thermal power dissipation of the energy supply device. This can, for example, prevent a temperature being reached in the energy supply device at which the charging process must be interrupted, which would result in the charging current being deactivated for a defined time duration during the charging process.

The at least one thermal condition can, for example, comprise a thermal equilibrium condition, according to which the charging current is adjusted during the charging process in such a way that a temperature of the energy supply device remains essentially constant. In addition or alternatively, the at least one thermal condition can comprise an equilibrium condition between a power dissipation of the energy supply device and a cooling capacity of the charging device. The at least one thermal condition can additionally or alternatively comprise a temperature limitation condition, which in particular comprises regulating a temperature of the energy supply device to a defined temperature in the form of a setpoint value.

The defined temperature in the energy supply device can, for example, be regarded as essentially constant with a fluctuation within a tolerance range of +/-−5K, in particular +/−3K.

The at least one deposition information can comprise a calculated deposition information, which is based, for example, on a simulation model. A characteristic map can be saved in the simulation model, which provides deposition-specific characteristic map information associated with the energy supply device, in particular with the at least one cell unit. The characteristic map can also be a separate characteristic map, for example as a standalone database in the form of a so-called lookup table. The characteristic map can be saved in the form of a database or a data record in a memory unit. The simulation model can be a predictive and/or a descriptive simulation model. The deposition-specific characteristic map information can differ depending on temperature, state of charge, and/or charging current. In addition or alternatively, the at least one deposition information can comprise a measured deposition information, for example at a reference energy supply device, for a respective charging current and/or at a respective temperature. The at least one deposition information can comprise a degree of deposition. The at least one deposition information can be saved in a characteristic map in the form of measured deposition information. The at least one deposition information can additionally or alternatively be determined with at least one cell unit, which serves as a reference cell unit and/or as an experimental cell unit for the plurality of cell units of the energy supply device.

The at least one electrochemical condition can, for example, in particular for the entire charging process, comprise a greater-than condition or at least one inequality condition between a potential at the anode of the at least one cell unit and a reference electrode potential of the reaction material, for example in the following form: anode potential >0 volts against Li/Li+.

In addition to the at least one thermal condition, the at least one electrochemical condition can additionally or alternatively be limiting for the charging current.

The energy supply device can be formed as a lithium-ion battery pack, wherein the cell units of the energy supply device are based on and/or formed using lithium-ion storage technology. The energy supply device can be configured as a hand-held, manually tool-free mountable and demountable, and/or exchangeable energy supply device. The energy supply device can be configured to form a plug connection with the charging device directly. The energy supply device can be configured for supplying electrical energy to an electric tool in the form of a so-called power tool.

The method steps a), b), c) and/or d) can each be carried out simultaneously, partially overlapping in time and/or sequentially in time. The method steps a), b), c) and/or d) can each be carried out continuously in time, with interruptions and/or at a defined frequency. The charging process can thus include (temporal) interruptions.

According to a further aspect of the present invention, it can be provided that the adjustment of the first defined charging current to the second defined charging current is performed as a function of the evaluation criterion for which the second defined charging current, in particular a C-rate associated with the second defined charging current, is smaller in each case.

The C-rate represents, in particular, a measure of the charging and discharging rate of the energy supply device in relation to its nominal capacity.

By adjusting the first defined charging current to the second defined charging current as a function of the evaluation criterion for which the second defined charging current is smaller, it is possible, for example, to avoid thermal shutdown or deposition of the reaction material, i.e., Li plating.

It is possible that the adjustment of the first defined charging current to the second defined charging current is performed at a point in time and/or from a point in time when reaching and/or exceeding a limit temperature in the energy supply device, in particular in the at least one cell unit, and/or in the charging device is determined, wherein in particular the limit temperature depends on at least one environmental information associated with an environment of the energy supply device, in particular the at least one cell unit, and/or the charging device.

The limit temperature can be defined differently as a function of the material configuration of the at least one cell unit (e.g., electrode materials, insulation materials, electrolyte materials).

The environmental information can comprise, for example, an ambient temperature, an ambient temperature curve, a temporal change in an ambient temperature curve, and/or a rate of change in an ambient temperature curve within which the energy supply device and/or the charging device is located.

Determining the reaching and/or exceeding of a limit temperature in the energy supply device, in particular in the at least one cell unit, and/or in the charging device can be realized in particular by at least one sensor unit each associated with the energy supply device and/or the charging device. In addition or alternatively, the determination of the reaching and/or exceeding of a limit temperature in the energy supply device can be performed by calculation using a simulation model and/or as a function of a characteristic map as disclosed herein.

According to a further aspect of the present invention, it can be provided that the adjustment of the first defined charging current to the second defined charging current is performed as a function of at least one operating information, which comprises at least one of the following: • a reduction factor for reducing the second defined charging current by a defined proportion, wherein the reduction factor is essentially constant or variable; • a defined tolerance range at least for the second defined charging current.

The reduction factor can, for example, be configured to reduce the second defined charging current in a range from 1 percent to 5 percent. The tolerance range for the second defined charging current can, for example, be 2 percent, in particular 1 percent.

It is possible that determining of the at least one heat information comprises: • determining at least one heat loss information associated with the energy supply device, in particular the at least one cell unit; and • determining at least one charging cooling information associated with the charging device and/or the energy supply device, in particular the at least one cell unit; wherein, in particular, the at least one first evaluation criterion comprises an equilibrium condition between a power loss of the energy supply device and a cooling capacity of the charging device.

According to a further aspect of the present invention, the method can comprise: • retrieving, measuring, and/or calculating at least one heating capacity and/or a change in at least one heating capacity associated with the energy supply device, in particular the at least one cell unit, during a cooling process prior to the charging process; • retrieving, measuring, and/or calculating at least one cooling capacity and/or a change in at least one cooling capacity associated with the charging device during a cooling process prior to the charging process; • retrieving, measuring, and/or calculating at least one heating capacity and/or a change in at least one heating capacity associated with the energy supply device, in particular the at least one cell unit, during the charging process, in particular at least up to a point in time at and/or from which the first defined charging current is adjusted to the second defined charging current; and/or • retrieving, measuring, and/or calculating at least one cooling capacity and/or a change in at least one cooling capacity associated with the charging device during the charging process, in particular at least up to a point in time at and/or from which the first defined charging current is adjusted to the second defined charging current; and in each case assigning the respective at least one heating capacity to the at least one heat information, in particular to at least one heat loss information, and/or in each case assigning the respective at least one cooling capacity to the at least one heat information, in particular to at least one charging cooling information.

The retrieval can be realized in conjunction with a memory unit of the energy supply device and/or the charging device, in which, for example, the heating capacity and/or the cooling capacity are saved. The measurement can be realized in conjunction with a sensor unit of the energy supply device and/or the charging device. The calculation can be realized in conjunction with a computing unit of the energy supply device and/or the charging device.

It is possible that the method comprises: • determining, in particular measuring, at least one environmental information associated with an environment of the energy supply device, in particular the at least one cell unit, and/or an environment of the charging device; • repeating at least one of the method steps a), b), c) and/or d) in each case as a function of the at least one environmental information.

As already disclosed herein, the at least one environmental information can comprise information relating to an environment in which the energy supply device and/or the charging device is located. The at least one environmental information can comprise an ambient temperature and/or an ambient pressure.

According to a further aspect of the present invention, the method can comprise • retrieving, measuring, and/or calculating at least one potential and/or a change in at least one potential associated with the anode of the at least one cell unit; • retrieving, measuring, and/or calculating at least one state of charge and/or a change in at least one state of charge associated with the energy supply device, in particular the at least one cell unit; • retrieving, measuring, and/or calculating at least one ambient temperature and/or a change in at least one ambient temperature associated with an environment of the energy supply device, in particular the at least one cell unit; • retrieving, measuring, and/or calculating at least one cell temperature and/or a change in at least one cell temperature associated with the at least one cell unit; and in each case assigning the at least one potential, the at least one state of charge, the at least one ambient temperature, and/or the at least one cell temperature to the at least one deposition information.

The method can comprise: • determining at least one lifetime information associated with the energy supply device, in particular the at least one cell unit; • repeating at least one of the method steps a), b), c) and/or d) in each case as a function of the at least one lifetime information.

The at least one lifetime information can, for example, comprise a value, a history, a change over time, and/or a rate of change of at least one of the following: a number of charge-discharge cycles, an accumulated charge quantity, an electrical resistance.

According to a further aspect of the present invention, the method can comprise: • retrieving, measuring, and/or calculating at least one internal resistance and/or a change in at least one internal resistance associated with the energy supply device, in particular the at least one cell unit; • retrieving, measuring, and/or calculating at least one capacity and/or a change in at least one capacity associated with the energy supply device, in particular the at least one cell unit; • retrieving, measuring, and/or calculating at least one cumulative charging energy and/or a change in at least one cumulative charging energy associated with the energy supply device, in particular the at least one cell unit; and/or • retrieving, measuring, and/or calculating at least one charging process number and/or a change in at least one charging process number associated with the energy supply device, in particular the at least one cell unit; and in each case assigning the at least one internal resistance, the at least one capacity, the at least one cumulative charging energy and/or the at least one charging process number to the at least one lifetime information.

This means that the method according to the present invention can also take into account the effect of aging of the energy supply device, for example in addition to the deposition effect.

According to a further aspect of the present invention, the method can comprise: • determining at least one charging power information associated with the charging device; • adjusting, in particular controlling and/or regulating, the first defined charging current to the second defined charging current until at least one third evaluation criterion, which comprises at least one power condition, is fulfilled by the at least one charging power information, in order to set, essentially maintain, and/or not exceed a maximum permissible charging power of the charging device; wherein the adjustment of the first defined charging current to the second defined charging current is performed temporally before and/or independently of the fulfillment of the first evaluation criterion and/or the second evaluation criterion.

This allows, for example, the charging process to be made more efficient and heat generation at the energy supply device to be reduced, which is associated with, for example, an extension of the lifetime.

The at least one charging power information can comprise a charging current strength and/or a charging voltage, and/or a respective change and/or a respective change rate of the charging current strength and/or the charging voltage.

The method can comprise: • deactivating the supply of the first defined charging current and/or drawing a defined supplied charging current provided from the energy supply device, in particular from the at least one cell unit, until at least one evaluation criterion is fulfilled.

The deactivation can be performed for a defined time duration (interruption) and/or be part of the charging process. The at least one evaluation criterion can be characterized as disclosed herein.

According to a further aspect of the present invention, the method can comprise: • setting, in particular controlling and/or regulating, a cooling unit of the charging device for generating a media flow for cooling the energy supply device, in particular the at least one cell unit, by a charging management unit of the energy supply device until the at least one first evaluation criterion and/or the at least one second evaluation criterion is fulfilled.

This allows, for example, a cooling effect on the energy supply device to be taken into account during the charging process. The media flow can in particular be an air flow.

According to a further aspect of the present invention, it can be provided that the at least one first evaluation criterion and the at least one second evaluation criterion is associated with a characteristic map with at least one characteristic map information; wherein the characteristic map is an at least two-dimensional characteristic map and/or wherein the at least one characteristic map information is at least partially retrieved, measured, and/or calculated.

It is possible that at least the supply of the first defined charging current, the determination of the at least one heat information, the determination of the at least

one deposition information, and/or the adjustment of the first defined charging current to the second defined charging current is carried out at least partially together and/or alternately by means of at least one of the following units: • a charging management unit of the energy supply device, • a charging control unit of the charging device.

The charging management unit is, in particular, the so-called battery management system of the energy supply device. The charging control unit is, in particular, the control unit of the charging device.

The present invention relates, from a second general point of view, to a charging device for charging an energy supply device for an electric tool during a charging process, wherein the energy supply device comprises a plurality of cell units, wherein the charging device comprises: • a cooling unit for generating a media flow for cooling the energy supply device during the charging process; • a charging control unit for establishing a communication connection with the energy supply device, in particular with a charging management unit of the energy supply device, wherein the charging control unit is configured a) for determination at least one heat information associated with the energy supply device, in particular at least one cell unit, and/or the charging device; b) for determination at least one deposition information associated with a reaction material at an anode of at least one of the cell units; c) for supplying a first defined charging current to the energy supply device, in particular to at least one cell unit; and d) for adjusting, in particular controlling and/or regulating, the first defined charging current to a second defined charging current until • at least one first evaluation criterion, which comprises at least one thermal condition, is fulfilled by the at least one heat information, in order to set, essentially maintain and/or not exceed a defined temperature in the energy supply device, in particular in the at least one cell unit; and/or • at least one second evaluation criterion, which comprises at least one electrochemical condition, is fulfilled by the at least one deposition information, in order to essentially avoid or at least limit, in a defined manner, a deposition, in particular a plating, of the reaction material at the anode of the at least one cell unit; wherein, in particular, the charging device is configured to carry out a method as disclosed herein.

The present invention relates, from a third general point of view, to an energy supply device for an electric tool, which comprises a plurality of cell units and is configured for charging by means of a charging device during a charging process, wherein the energy supply device comprises: • a charging management unit for establishing a communication connection with the charging device, in particular with a charging control unit of the charging device, wherein the charging management unit is configured a) for determining at least one heat information associated with the energy supply device, in particular at least one cell unit, and/or the charging device; b) for determining at least one deposition information associated with a reaction material at an anode of at least one of the cell units; c) for supplying a first defined charging current to the energy supply device, in particular to at least one cell unit; and d) for adjusting, in particular controlling and/or regulating, the first defined charging current to a second defined charging current until • at least one first evaluation criterion, which comprises at least one thermal condition, is fulfilled by the at least one heat information, in order to set, essentially maintain and/or not exceed a defined temperature in the energy supply device, in particular in the at least one cell unit; • at least one second evaluation criterion, which comprises at least one electrochemical condition, is fulfilled by the at least one deposition information, in order to avoid or at least limit, in a defined manner, a deposition, in particular a plating, of the reaction material at the anode of the at least one cell unit; wherein, in particular, the energy supply device is configured to carry out a method as disclosed herein.

The present invention relates, from a fourth general point of view, to a computer program product, comprising a computer program code saved on a machine-readable medium and/or represented by at least one electromagnetic wave comprising at least one computer program code segment of the computer program code, wherein the computer program code comprises computer-executable instructions for carrying out a method for charging an energy supply device as disclosed herein, in particular when carried out on a charging device as disclosed herein and/or on an energy supply device as disclosed herein.

The present invention relates, from a fifth general point of view, to a system with at least one energy supply device as disclosed herein and a charging device as disclosed herein, wherein the system is configured to carry out a method for charging the energy supply device by means of the charging device as disclosed herein.

To avoid repetition, features directed purely at the apparatus of the energy supply device according to the invention and/or the charging device according to the invention and/or disclosed in connection therewith shall also be deemed to be disclosed as part of the method and shall be claimable, and vice versa.

In another embodiment of the invention, it is an object of this invention to provide a method for charging an energy supply device, in particular a hand-held, manually tool-free mountable and demountable, and/or exchangeable energy supply device for an electric tool by means of a charging device during a charging process at comparatively deep (low) temperatures, wherein the method is characterized in particular with regard to the energy supply device by a shorter time duration for the charging process and/or by less aging. Furthermore, it is an object of the present invention to provide a charging device and an energy supply device, each of which is configured to carry out the method according to the present invention.

The object is solved by the features of claims 11, 19, and 20. Further embodiments and applications of the present invention are apparent from the dependent claims and are explained in more detail in the following description with partial reference to the figures.

The present invention relates, from a first general point of view, to a method for charging an energy supply device for an electric tool by means of a charging device during a charging process, wherein the energy supply device comprises at least one cell unit, with the method steps: a) determining at least one temperature and at least one state of charge, wherein the (determined) at least one temperature and the (determined) at least one state of charge are each associated with the energy supply device, in particular to the at least one cell unit; b) calculating at least one charging profile information as a function of the (determined) at least one temperature, the (determined) at least one state of charge and at least one target state-of-charge information using a charging profile model with at least one model information for setting, in particular regulating and/or controlling, a charging and/or a discharging of the energy supply device, in particular of the at least one cell unit, wherein the at least one charging profile information comprises a charging process duration associated with the charging process, and wherein the at least one model information comprises a deposition information associated with a reaction material of the energy supply device, in particular at an anode of the at least one cell unit; cE) drawing a discharging current from the energy supply device, in particular from the at least one cell unit, during at least one discharging phase, and cB) supplying a charging current to the energy supply device, in particular to the at least one cell unit, during at least one charging phase, in each case as a function of the calculated at least one charging profile information, in order to minimize the charging process duration and/or to substantially avoid or at least limit, in a defined manner, a deposition, in particular a plating, of the reaction material in the energy supply device, in particular at an anode of the at least one cell unit, and/or to set a defined temperature in the energy supply device, in particular in the at least one cell unit.

The present invention provides a method for charging (charging method) for an energy supply device which, in particular, at the beginning of a charging process at initially comparatively deep (low) temperatures, for example less than 0 degrees Celsius, carries out a charging process that is optimized in particular with regard to a time duration until, in particular, a target state of charge of the energy supply device is essentially reached. The method according to the present invention is also characterized in particular by the fact that, at comparatively deep (low) temperatures, deposition effects of a reaction material, for example in the form of lithium, or aging effects can be essentially avoided, limited in a defined manner, and/or at least significantly reduced.

The energy supply device can comprise, for example, a single cell unit or a plurality of cell units. The energy supply device can be formed as a lithium-ion battery pack, wherein the cell units of the energy supply device are based on and/or formed using lithium-ion storage technology. The energy supply device can be configured as a hand-held, manually tool-free mountable and demountable, and/or exchangeable energy supply device. The energy supply device can be configured to form a plug connection with the charging device directly. The energy supply device can be configured for supplying electrical energy to an electric tool in the form of a so-called power tool.

The target state-of-charge information can be user-defined and/or determined, in particular calculated, target state-of-charge information and can comprise, for example, a target state of charge of the energy supply device, for example approximately 80 percent, and/or a maximum time duration for the charging process, for example approximately 90 minutes.

The charging process duration can be at least an estimated minimum and/or maximum time duration for the charging process, which is calculated at the start of the charging process, for example immediately after determining the at least one temperature and the at least one state of charge. The charging process duration

can comprise a sum of the time duration for at least one discharging phase (discharging time duration) and the time duration for at least one charging phase (charging time duration).

The at least one charging profile information can be a changing charging profile information during the charging process, for example, as a function of at least one further temperature determined by and/or at least one further state of charge determined at a respective point in time.

The at least one charging profile information can comprise a defined point in time and/or a defined time duration for the at least one discharging phase and/or for the at least one charging phase. The at least one charging profile information can comprise an absolute value (amount) for at least one discharging current of at least one discharging phase and/or for at least one charging current of at least one charging phase. The at least one charging profile information can predictively define at least one section of the charging process or the charging process (as a whole).

A charging process of the energy supply device within the meaning of the present invention comprises, in particular, at least one discharging phase with a withdrawal of a discharging current and at least one charging phase with a supplying of a charging current.

The charging profile model can comprise at least one charging process simulation model with at least one simulation calculation function. In addition or alternatively, the charging profile model can comprise at least one charging process characteristic map model with at least one characteristic map query function. The at least one charging profile information can be at least one simulation-based and/or characteristic map-based charging profile information.

The at least one model information can comprise a deposition information calculated by the charging process simulation model. A characteristic map can be saved in the charging process simulation model, which provides deposition-specific characteristic map information that is associated with the energy supply device, in particular the at least one cell unit. The characteristic map can also be a separate characteristic map, for example as a standalone database in the form of a so-called lookup table. The characteristic map can be saved in the form of a database or a data record in a memory unit. The charging process simulation model can be a predictive and/or descriptive simulation model. The deposition-specific characteristic map information can differ depending on temperature, state of charge, and/or charging current.

In addition or alternatively, the deposition information can comprise a measured deposition information, for example at a reference energy supply device, for a respective charging current and/or at a respective temperature. The deposition information can comprise a degree of deposition. The deposition information can be saved in a characteristic map in the form of measured deposition information. The deposition information can additionally or alternatively be determined with at least one cell unit, which serves as a reference cell unit and/or as an experimental cell unit for the at least one cell unit or for the plurality of cell units of the energy supply device. The at least one model information can be relevant for drawing a discharging current during at least one discharging phase and/or for supplying a charging current during at least one charging phase.

The method according to the present invention comprises, among other things, drawing a charging current, which is primarily accompanied by a heating of the energy supply device, in particular of the at least one cell unit, at comparatively deep (low) temperatures. By means of the method according to the present invention, the energy supply device can, for example, also be conditioned for optimum operation after a charging process that is, heated, in order to be able to ensure an electrical

energy supply of an electric tool at cold ambient and/or outside temperatures (for example, winter temperatures).

The method steps a) and b) can be carried out essentially simultaneously, partially overlapping in time and/or sequentially in time. The method steps a), b), cE) and/or cB) can be carried out continuously in time, with interruptions and/or at a defined frequency. The charging process can include (temporal) interruptions.

According to a further aspect of the present invention, it can be provided that, in particular at the start of the charging process, the at least one discharging phase is carried out before the at least one charging phase if the determined at least one temperature is less than or at least equal to a defined low temperature threshold value, and/or if the determined at least one state of charge is greater than 0 percent and/or greater than a defined state-of-discharge threshold value, in each case to heat the energy supply device, in particular the at least one cell unit, until a temperature of the energy supply device, in particular the at least one cell unit, essentially reaches and/or exceeds at least a first charging temperature threshold value.

The defined low temperature threshold value can, for example, be approximately 0 degrees Celsius. The defined state-of-discharge threshold value can, for example, be approximately 5 percent of a capacity of the energy supply device. The at least one discharging phase can be carried out in particular at the start of the charging process temporally before at least one charging phase if the determined state of charge of the energy supply device, in particular of the at least one cell unit, is greater than the defined state-of-discharge threshold value.

It is possible that the discharging current for the at least one discharging phase and/or a discharging time duration for the at least one discharging phase is set in each case such that a voltage of the energy supply device, in particular of the at least one cell unit, does not fall below at least one cut-off voltage limit value.

The cut-off voltage limit value can be defined depending on the configuration of the at least one cell unit and can, for example, lie between approximately 2.5 volts and approximately 3.0 volts (per cell unit). This can, for example, prevent a deep discharge of the energy supply device, in particular of the at least one cell unit.

According to a further aspect of the present invention, it can be provided that the discharging current for the at least one discharging phase and/or a discharging time duration for the at least one discharging phase is set in each case such that a state of charge of the energy supply device, in particular the at least one cell unit, does not fall below at least one deep state-of-charge limit value.

It is possible that a discharging time duration is set for the at least one discharging phase, in particular as a function of a rate of change of the determined at least one state of charge, which is shorter, in particular always shorter, than a charging time duration for the at least one charging phase.

The at least one discharging phase serves in particular and/or essentially to heat the energy supply device, i.e. for realization a defined temperature increase in order to be able to optimally carry out further phases of the charging process.

According to a further aspect of the present invention, it can be provided that an absolute value (magnitude) of the discharging current for the at least one discharging phase is set to be greater, in particular always greater, than an absolute value (magnitude) of the charging current for the at least one charging phase.

In other words, the magnitude of a discharging current for the at least one discharging phase can be greater than a magnitude of a charging current for the at least one charging phase, in order to realize, in particular, a defined heating of the at least one cell unit of the energy supply device.

It is possible that the charging current for at least one second charging phase, which follows at least one first charging phase and at least one discharging phase and/or is carried out, is set to be at least in sections equal to or greater than the charging current for the at least one first charging phase.

By setting the charging current for the respective charging phase in this way, the time duration of the charging process can be further minimized.

According to a further aspect of the present invention, it can be provided that the charging current for at least one second charging phase, which follows at least one first charging phase and at least one discharging phase and/or is carried out, is set to be at least in sections equal to or greater than the charging current for the at least one first charging phase.

It is possible that the discharging current for at least one second discharging phase, which follows at least one first discharging phase and at least one charging phase and/or is carried out, is set such that a state of charge after the at least one second discharging phase is equal to or greater than a state of charge after the at least one first discharging phase.

According to a further aspect of the present invention, it can be provided that, after a first discharging phase and after a charging phase, a second discharging phase is performed and/or is performed if, by supplying, in particular reducing, the charging current during the charging phase, a temperature of the energy supply device, in particular the at least one cell unit, lies below at least a second charging temperature threshold value, in order to heat the energy supply device, in particular the at least one cell unit, until the temperature of the energy supply device, in particular of the at least one cell unit, essentially reaches and/or exceeds the at least one second charging temperature threshold value.

It is possible that, upon reaching and/or exceeding the second charging temperature threshold value, the charging process can be carried out with a charging phase with an essentially constant charging current for a defined charging time duration (also abbreviated as “CC phase”) and followed by a charging phase with an essentially constant charging voltage for a defined charging time duration (also abbreviated as “CV phase”).

The method can comprise: deactivating the withdrawal of the discharging current if a temperature of the energy supply device, in particular of the at least one cell unit, essentially reaches and/or exceeds at least one second charging temperature threshold value.

According to a further aspect of the present invention, the method can comprise: • determining at least one lifetime information associated with the energy supply device, in particular the at least one cell unit; • calculating the at least one charging profile information as a function of the determined at least one lifetime information.

It is possible that the at least one lifetime information is determined using the charging profile model as disclosed herein.

It is possible that the method comprises: • retrieving, measuring and/or calculating at least one internal resistance and/or a change in at least one internal resistance associated with the energy supply device, in particular the at least one cell unit (11, 12); • retrieving, measuring, and/or calculating at least one capacity and/or a change in at least one capacity associated with the energy supply device, in particular the at least one cell unit; • retrieving, measuring, and/or calculating at least one cumulative charging energy and/or a change in at least one cumulative charging energy associated with the energy supply device, in particular the at least one cell unit; and/or • retrieving, measuring, and/or calculating at least one charging process number and/or a change in at least one charging process number associated with the energy supply device, in particular the at least one cell unit; and in each case assigning the at least one internal resistance, the at least one capacity, the at least one cumulative charging energy and/or the at least one charging process number to the at least one lifetime information.

According to a further aspect of the present invention, it can be provided that the determining of the at least one temperature comprises: • retrieving, measuring and/or calculating the at least one temperature and/or a change in the at least one temperature at least before the at least one discharging phase and/or at least before the at least one charging phase.

According to a further aspect of the present invention, the method can comprise: •retrieving, measuring and/or calculating at least one ambient temperature and/or a change in at least one ambient temperature associated with an environment of the energy supply device, in particular the at least one cell unit; • calculating the at least one charging profile information as a function of the retrieved, measured, and/or calculated at least one ambient temperature.

This allows, for example, the method according to the present invention and thus the drawing of the discharging current and/or the supplying of the charging current to be further improved by taking into account an ambient temperature and/or a change in an ambient temperature.

It is possible that the determining the at least one state of charge comprises: • retrieving, measuring, and/or calculating the at least one state of charge and/or a change in the at least one state of charge at least before the at least one discharging phase and/or at least before the at least one charging phase.

It is possible that the method comprises: • transmitting the withdrawn discharging current to at least one further cell unit of the energy supply device or to at least one further energy supply device with at least one cell unit as a function of at least one temperature of the at least one further energy supply device and/or an ambient temperature associated with an environment of the at least one further energy supply device.

According to a further aspect of the present invention, it can be provided that at least the determination of the at least one temperature, the determination of the at least one state of charge, the calculation of the at least one charging profile information, the drawing of the discharging current and/or the supply of the charging current is carried out at least partially together and/or alternately by means of at least one of the following units: • a charging management unit of the energy supply device, • a charging control unit of the charging device, • a central unit of a charging system which is connected to the energy supply device and/or to the charging device.

The central unit can be connected to the energy supply device and/or the charging device wirelessly and/or by wire. The central unit can, for example, be formed as a so-called charging hub. The charging system can be characterized by a charging infrastructure with several charging devices as disclosed herein and can, for example, comprise a cloud-based charging application, i.e., charging software.

The present invention relates, from a second general point of view, to a charging device for charging an energy supply device for an electric tool during a charging process, wherein the energy supply device comprises at least one cell unit, wherein the charging device comprises: • a charging control unit for establishing a communication connection with the energy supply device, in particular with a charging management unit of the energy supply device, wherein the charging control unit is configured: a) to determine at least one temperature and at least one state of charge, each of which are associated with the energy supply device, in particular with the at least one cell unit; b) to calculate at least one charging profile information as a function of the at least one temperature, the at least one state of charge and at least one target state-of-charge information using a charging profile model with at least one model information for setting, in particular regulating and/or controlling, a charging and/or a discharging of the energy supply device, in particular of the at least one cell unit, wherein the at least one charging profile information comprises a charging process duration associated with the charging process, and wherein the at least one model information comprises a deposition information associated with a reaction material of the energy supply device, in particular at an anode of the at least one cell unit; cE) for drawing a discharging current from the energy supply device, in particular from the at least one cell unit, during at least one discharging phase, and cB) for supplying a charging current to the energy supply device, in particular to the at least one cell unit, during at least one charging phase; in order, depending on the calculated at least one charging profile information, to minimize the charging process duration and/or essentially avoid or at least limit a deposition, in particular a plating, of the reaction material in the energy supply device, in particular at an anode of the at least one cell unit, in each case; wherein, in particular, the charging device is configured to carry out a method as disclosed herein.

The present invention relates, from a third general point of view, to an energy supply device for an electric tool, which comprises at least one cell unit and is configured for charging by means of a charging device during a charging process, wherein the energy supply device comprises: • a charging management unit for establishing a communication connection with the charging device, in particular with a charging control unit of the charging device, wherein the charging management unit is configured: a) to determine at least one temperature and at least one state of charge, each of which are associated with the energy supply device, in particular with the at least one cell unit; b) to calculate at least one charging profile information as a function of the at least one temperature, the at least one state of charge and at least one target state-of-charge information using a charging profile model with at least one model information for setting, in particular regulating and/or controlling, a charging and/or a discharging of the energy supply device, in particular of the at least one cell unit, wherein the at least one charging profile information comprises a charging process duration associated with the charging process, and wherein the at least one model information comprises a deposition information associated with a reaction material of the energy supply device, in particular at an anode of the at least one cell unit; cE) for drawing a discharging current from the energy supply device, in particular from the at least one cell unit, during at least one discharging phase, and cB) for supplying a charging current to the energy supply device, in particular to the at least one cell unit, during at least one charging phase; in order, depending on the calculated at least one charging profile information, to minimize the charging process duration and/or essentially avoid or at least limit deposition, in particular a plating, of the reaction material in the energy supply device, in particular at an anode of the at least one cell unit, in each case; wherein, in particular, the energy supply device is configured to carry out a method as disclosed herein.

The present invention relates, from a fourth general point of view, to a computer program product comprising computer program code saved on a machine-readable medium and/or represented by at least one electromagnetic wave comprising at least one computer program code segment of the computer program code, wherein the computer program code comprises computer-executable instructions for carrying out a method for charging an energy supply device as disclosed herein, in particular when carried out on a charging device as disclosed herein and/or on an energy supply device as disclosed herein.

The present invention relates, from a fifth general point of view, to a system and/or an arrangement with at least one energy supply device as disclosed herein and with a charging device as disclosed herein, wherein the system and/or the arrangement is configured to carry out a method for charging the energy supply device by means of the charging device as disclosed herein.

To avoid repetition, features directed purely at the apparatus of the energy supply device according to the invention and/or the charging device according to the invention and/or disclosed in connection therewith shall also be deemed to be disclosed as part of the method and be claimable, and vice versa.

### BRIEF DESCRIPTION OF THE DRAWINGS

The embodiments and features of the present invention described above can be combined with each other in any manner or as appropriate. Further or other details and advantageous effects of the present invention are explained in more detail below with reference to the accompanying figures.

it shows:

FIG. 1 is a first embodiment of the energy supply device according to the present invention in a perspective view, wherein some units of the energy supply device are shown individually highlighted;

FIG. 2 is a system with the energy supply device from FIG. 1 and with a first embodiment of a charging device according to the present invention in a perspective view, wherein some units of the energy supply device and the charging device are shown individually highlighted;

FIG. 3 is an embodiment of an electric tool that is detachably electrically and detachably mechanically coupled to the energy supply device in order to supply the electric tool with electrical energy in an operating state;

FIG. 4 is a flowchart of a first embodiment of the method according to the present invention;

FIG. 5 is a charging diagram of an energy supply device during a charging process according to a first embodiment of the method according to the present invention;

FIG. 6 is a charging diagram of an energy supply device during a charging process according to a charging method from the prior art;

FIG. 7 is a charging diagram of the energy supply device during a charging process according to the first embodiment of the method according to the present invention and according to a charging method from the prior art;

FIG. 8 is a temperature curve in the energy supply device during a charging process according to the first embodiment of the method according to the present invention and according to a charging method from the prior art;

FIG. 9 is a characteristic map for applying an embodiment of the method according to the present invention;

FIG. 10A is a view of charging diagrams of an energy supply device according to a charging method from the prior art;

FIG. 10B is a view of charging diagrams of an energy supply device according to a second embodiment of the method according to the present invention;

FIG. 10C is a view of charging diagrams of an energy supply device according to a third embodiment of the method according to the present invention; and

FIG. 11 is a view of an embodiment of the energy supply device according to the present invention in a perspective view, wherein some units of the energy supply device are shown individually highlighted;

FIG. 12 is a view of a system with the energy supply device from FIG. 11 and with an embodiment of a charging device according to the present invention in a perspective view, wherein some units of the energy supply device and the charging device are shown individually highlighted;

FIG. 13 is a view of an embodiment of an electric tool that is detachably electrically and mechanically coupled to the energy supply device in order to supply the electric tool with electrical energy in an operating state;

FIG. 14 is a view of a flowchart of an embodiment of the method according to the present invention;

FIG. 15 is a view of several charge diagrams of the charging process according to the embodiment of the method according to the present invention, showing the curve of a charging current, a discharging current, a charging voltage, a temperature, and a state of charge;

FIG. 16 is a view of a section of a charging diagram of an energy supply device during a charging process according to a second embodiment of the method according to the present invention, showing the curve of a charging current and a discharging current;

FIG. 17 is a view of an excerpt from a further charging diagram of the charging process according to the second embodiment of the method, showing a curve of a temperature;

FIG. 18 is a view of an excerpt from a further charging diagram of the charging process according to the second embodiment of the method, showing the curve of a state of charge;

FIG. 19 is a view of an excerpt from a further charging diagram of the charging process according to the second embodiment of the method, illustrating a curve of a voltage.

Identical or functionally equivalent devices, units, or elements are marked with the same reference signs in the figures. For the sake of clarity, reference is also made in part to the description of other embodiments and/or figures in order to avoid repetition.

### DETAILED DESCRIPTION

The following detailed description of the embodiments shown in the figures serves for further illustration or clarification and is not intended to limit the scope of the present invention in any way.

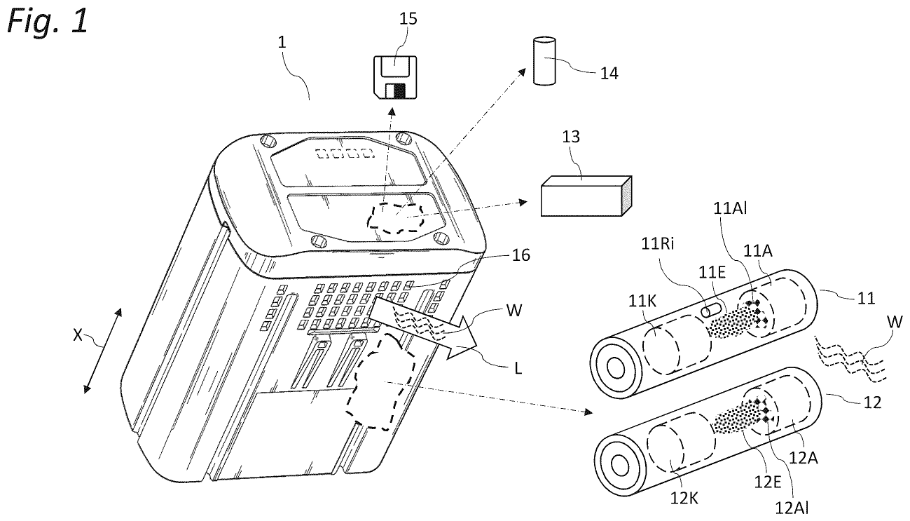

FIG. 1 shows a first embodiment of the energy supply device 1 according to the present invention in a perspective view, wherein some units of the energy supply device are shown individually highlighted.

The energy supply device 1 is a separate and/or independent device 1 for storing electrical energy during a charging process and/or for delivering electrical energy during a discharging process. The energy supply device 1 is configured as an electrical energy source for an electric tool 3 to supply electrical energy to the electric tool 3.

The electric tool 3 can be a mobile, portable, manually operated, self-sufficient (mains-independent) and/or motor-driven electric tool 3.

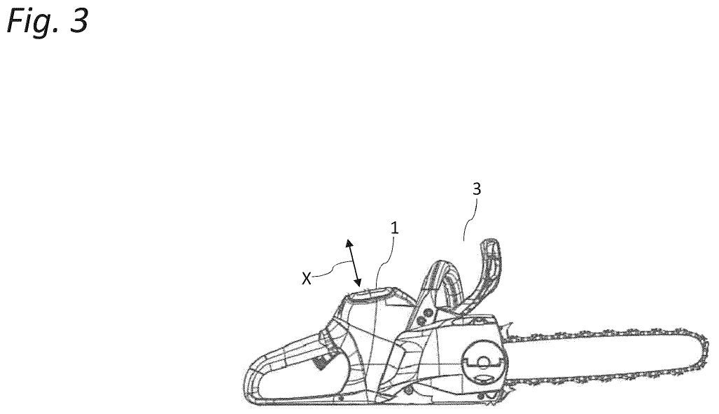

FIG. 3 shows an example of an electric tool 3 in the form of an electric motor-operated chainsaw 3 for illustrative purposes. The energy supply device 1 is exchangeably accommodated in a compartment of the electric tool 3, in particular by means of an installation process in the form of an insertion process in an installation direction X.

The energy supply device 1 is formed as a portable, manually tool-free mountable and demountable, and/or exchangeable battery pack 1. The energy supply device 1 is formed as a rechargeable electrical energy supply device 1 and comprises a plurality of cell units, of which cell unit 11 and cell unit 12 are highlighted in FIG. 1 for closer illustration.

The energy supply device 1 comprises a charging management unit 13, which is configured in particular for monitoring a charging process. The charging management unit 13 is configured during a charging process to distribute, in particular to control and/or regulate, a supplied charging current I_L to at least one cell unit 11, 12, in particular to the plurality of cell units 11, 12. In addition or alternatively, the charging management unit 13 is configured during a discharging process to draw, in particular to control and/or regulate, a discharging current (stored charging current) from the at least one cell unit 11, 12, in particular from the plurality of cell units 11, 12.

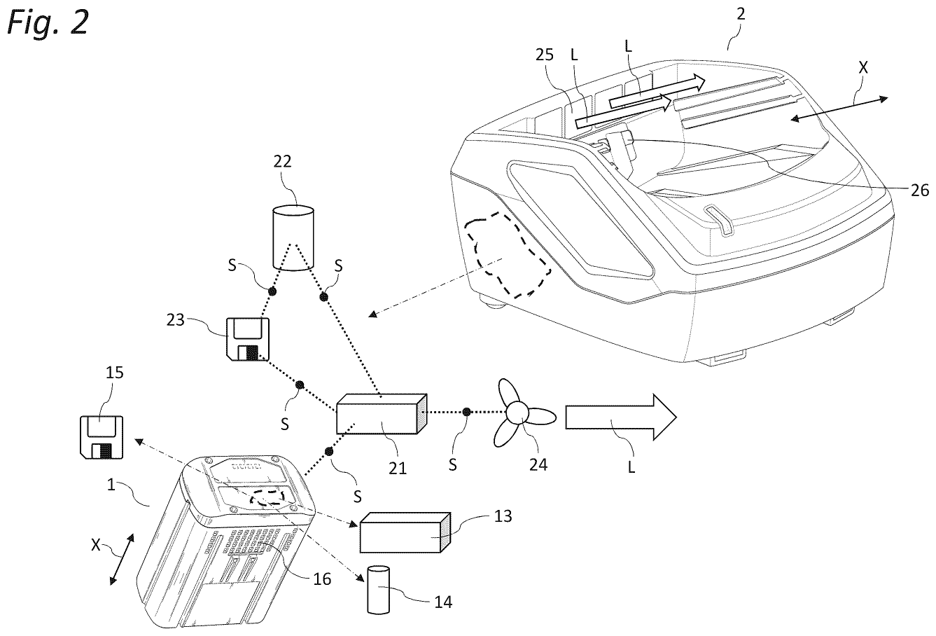

The charging management unit 13 can be configured by hardware and/or software to realize functions in connection with a charging process and/or a discharging process in accordance with its intended purpose. The charging management unit 13 is further configured in particular to establish a communication connection with a charging device 2 by means of at least one signal S (see FIG. 2). The at least one signal S is in particular an electrically and/or electronically processable signal S. The at least one signal S comprises at least one information and/or is associated with at least one information. The charging management unit 13 can, for example, comprise a computing unit with at least one computing core, which is configured to carry out at least one algorithm of a computer program for a charging process. The at least one algorithm is in particular configured as processable and/or executable computer program code.

The energy supply device 1 can be formed as an energy supply device known from the prior art. Each or at least one cell unit 11, 12 of the plurality of cell units 11, 12 comprises, in particular, an anode 11A, 12A and a cathode 11K, 12K as well as an electrolyte 11E, 12E. The respective anode 11A, 12A, cathode 11K, 12K, and electrolyte 11E, 12E can be formed from corresponding materials or combinations of materials in order to realize an electrochemical storage of electrical energy and withdrawal of stored electrical energy.

Furthermore, FIG. 1 shows a respective deposit 11Al at the anode 11A of the cell unit 11 and a deposit 12Al at the anode 12A of the cell unit 12, which are intended to illustrate the deposition of a reaction material, for example lithium. With regard to an internal resistance that characterizes the cell units 11, 12, the internal resistance 11Ri is shown symbolically and/or schematically in FIG. 1. The internal resistance 11Ri is also referred to as impedance and represents a measure of the resistance that the current flow experiences within the respective cell unit 11, 12. The internal resistance 11Ri significantly influences the performance and efficiency of the cell unit 11, 12. In other words, the internal resistance 11Ri is a parameter for assessing the condition and performance of the cell unit 11, 12 and therefore represents a lifetime information.

Each or at least one cell unit 11, 12 of the energy supply device 1 can be formed, for example, on the basis of one of the following electrical storage technologies: lithium-ion technology, lithium-polymer technology, lithium-metal technology (e.g., lithium-manganese technology), lithium-iron-phosphate technology, lithium-titanate technology, sodium-ion technology. It is possible that each or at least one cell unit 11, 12 of the energy supply device 1 comprises a liquid or solid electrolyte 11E, 12E.

The at least one cell unit 11, 12 can be characterized by a cell format in the form of a round cell or a pouch cell. It is also possible that the at least one cell unit 11, 12 is formed prismatic or cubic.

It is understood that each cell unit 11, 12 comprises further elements and/or is characterized by further elements, for example a housing, at least one sealing element, etc. However, for reasons of clarity, the further elements are not shown and/or labelled.

Cell units 11, 12 of a defined number of the plurality of cell units 11, 12 can each be combined into modules. The cell units 11, 12 or respective modules with several cell units 11, 12 can be arranged partly in a series connection and/or partly in a parallel connection to realize a respective configuration of the energy supply device 1. The entirety of the cell units 11, 12 can represent the so-called core pack of the energy supply device 1.

The energy supply device 1 comprises at least one sensor unit 14 for recording, in particular measuring, at least one information associated with the energy supply device 1 and/or the charging device 2. The at least one sensor unit 14 can be formed as a separate individual unit 14. Alternatively, the at least one sensor unit 14 can be part of the charging management unit 13 and/or integrated into the charging management unit 13.

The energy supply device 1 further comprises a memory unit 15 for permanent and/or volatile saving of at least one information associated with the energy supply device 1 and/or the charging device 2.

Furthermore, the energy supply device 1 comprises at least one channel 16. The channel 16 serves to remove heat W generated during a charging process in the cell units 11, 12 by means of an air flow L. The channel 16 can be part of an active cooling system between the energy supply device 1 and the charging device 2. The channel 16 can be connected to several air passage openings in a flow-mechanical manner, wherein at least one air passage opening is formed as an air inlet opening in relation to a housing of the energy supply device 1 and wherein at least one further air passage opening is formed as an air outlet opening.

In an alternative embodiment of the energy supply device 1, the energy supply device 1 is channel-free. In other words, the energy supply device 1 can be formed without air passage openings. The energy supply device 1 and/or the charging device 2 can each be characterized by a passive cooling system, wherein generated heat W is transferred and/or removed to an environment via respective housing walls and surfaces.

It is understood that the energy supply device 1 comprises further units and/or elements, and/or is characterized by further units and/or elements, for example a housing, a display unit, and/or at least one contact element for forming an electrical or electromagnetic connection with a contact element 26 of a charging device 2 assigned as a counter contact element. In a further embodiment, the energy supply device 1 can be configured for charging by means of induction. In other words, the energy supply device 1 can be configured to be charged inductively. Further units and/or elements are hidden, are not visible, and/or are not marked for reasons of clarity.

FIG. 2 shows a system with the energy supply device 1 from FIG. 1 and with a first embodiment of a charging device 2 according to the present invention in a perspective view. The units 13, 14, and 15 of the energy supply device 1, as well as some units of the charging device 2, are shown individually highlighted.

The charging device 2 is configured to charge the energy supply device 1 and thus to supply the cell units 11, 12 with electrical energy during a charging process. The charging process is carried out in an assembly state between the energy supply device 1 and the charging device 2, in which an electrical and a mechanical connection is formed.

The charging device 2 comprises the at least one contact element 26 as a counter-contact element to a contact element of the energy supply device 1, which is associated with it, for transmitting the electrical energy. It is understood that in addition to the at least one contact element 26 as a load contact element, the charging device 2 comprises at least one further contact element as a signal contact element for transmitting electrical signals S between the charging device 2 and an assembled, i.e., plugged-in, energy supply device 1.

In addition, the charging device 2 comprises a charging control unit 21. The charging control unit 21 is configured to provide, in particular to control and/or regulate, a charging current to the energy supply device 1 during a charging process. The charging control unit 21 can, for example, comprise a computing unit with at least one computing core, which is configured to carry out at least one algorithm of a

computer program for a charging process. The at least one algorithm is in particular configured as processable and/or executable computer program code.

To cool the cell units 11, 12 of the energy supply device 1 during a charging process, in particular during a fast charging process, the charging device 2 comprises a fan unit 24 for generating an air flow L with air from an environment of the charging device 2 as a cooling medium in order to apply the generated air flow L to the channel 16 of the energy supply device 1. For this purpose, the charging device 2 comprises at least one duct 25 through which a generated air flow L passes and/or exits and, in the assembly state of the energy supply device 1, enters the channel 16 via at least one passage opening of the energy supply device 1 in order to flow through it, absorb generated heat W, and transport it away.

The charging control unit 21 is configured to set the fan unit 24, in particular as a function of at least one operating information, in order to vary and thus adjust the air flow L. In particular, the charging control unit 21 is configured to control and/or regulate the fan unit 24 in order, for example, to realize a defined volume flow (flow rate), a defined idealized and/or resulting overpressure, and/or a defined idealized and/or resulting flow velocity of the air flow L.

In other words, the fan unit 24 serves as a blower for cooling the cell units 11, 12 of the energy supply device 1 by means of the air flow L. Heat W generated in and/or on the energy supply device 1 during the charging process can be dissipated, i.e., removed, by the air flow L as a result of convection, in particular forced convection (see also FIG. 1 with the heat W contained in the air flow L). The heat W generated

during the charging process at the energy supply device 1 as a result of conversion processes is also referred to as the so-called thermal loss energy of the energy supply device 1. The heat W can also result, at least in part, from a discharge process of the energy supply device 1. This can be the case if the energy supply device 1 undergoes a charging process immediately after the discharge process.

Alternatively or additionally, the charging management unit 13 of the energy supply device 1 can be configured to set the fan unit 24, in particular as a function of at least one operating information. It is also possible that the energy supply device 1 comprises a fan unit 24 as disclosed herein. The fan unit 24 can be integrated into a housing of the energy supply device 1.

During the charging process, heat W can also be generated at the charging device 2 as thermal loss energy.

The charging device 2 comprises at least one sensor unit 22 for recording, in particular measuring, information associated with the energy supply device 1 and/or the charging device 2. The at least one sensor unit 22 can be formed as a separate individual unit 22. Alternatively, the at least one sensor unit 22 can be part of the charging control unit 21 and/or integrated into the charging control unit 21. The at least one sensor unit 22 can be configured to record at least one temperature, one

pressure, and/or one speed of the air flow L.

The charging device 2 further comprises a memory unit 23 for permanent and/or volatile saving of at least one information associated with the energy supply device 1 and/or the charging device 2, in particular temporally before, during, and/or after a charging process. The memory unit 23 can be configured analogously to the memory unit 15 and vice versa.

The at least one information can be saved, for example, in the form of a characteristic map. The characteristic map can, for example, comprise at least two different characteristic map information with respective values, which are relevant for a charging process of the energy supply device 1, i.e. for at least one cell unit 11, 12.

It is understood that the charging device 2 comprises further units and/or elements, and/or is characterized by further units and/or elements, for example a housing, a converter unit with a transformer and with a rectifier for converting alternating current into direct current, and/or a display unit for outputting a status of the energy supply device 1 and/or the charging device 2. Further units and/or elements are hidden, are not visible, and/or are not marked for reasons of clarity. The charging device 2 can be configured as a charging device known from the prior art.

The charging management unit 13 and/or the charging control unit 21 are further configured to process at least one information as disclosed herein, in particular by means of at least one algorithm of a computer program for a charging process. The at least one algorithm is in particular configured as processable and/or executable computer program code.

In the following, the invention is described with reference to the method and by means of embodiments in which the cell units 11, 12 of the energy supply device 1 are formed on the basis of lithium-ion storage technology.

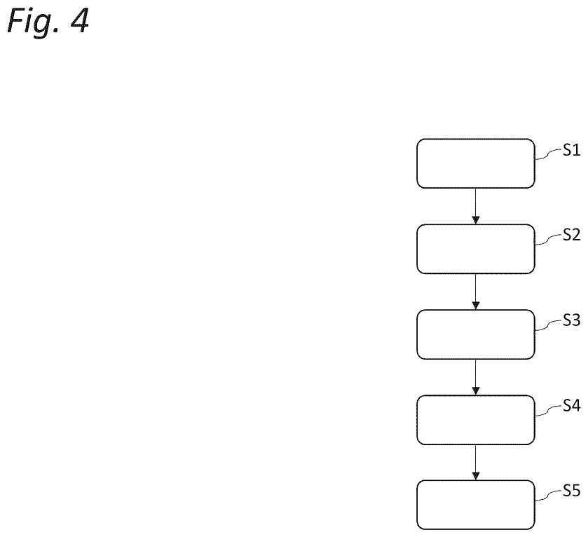

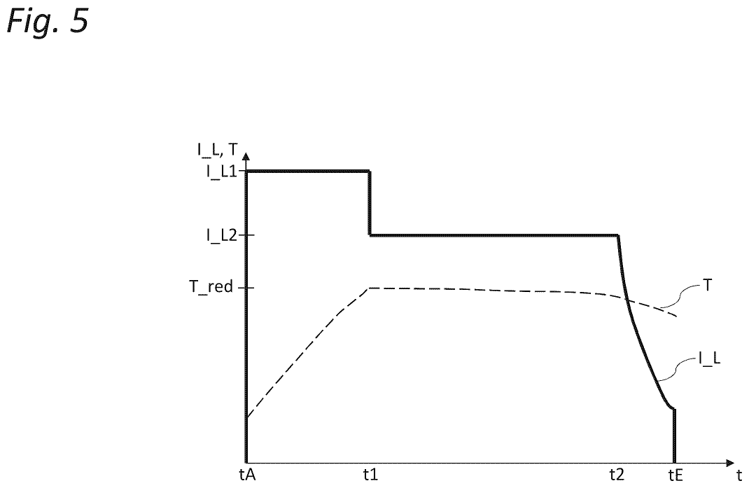

FIG. 4 shows a flowchart of a first embodiment of the method according to the present invention, and FIG. 5 shows a corresponding charging diagram, in which a possible curve of a supplied charging current I_L and a possible curve of a temperature T in the energy supply device 1 during the charging process, i.e., during the provision of the charging current I_L, are shown.

The method relates to a charging process of the energy supply device 1 as disclosed herein. The charging process can be divided into several charging phases based on points in time and/or time durations. The following describes the steps of the method with reference to FIGS. 4 and 5, wherein only partial reference is made to devices, units, and/or elements in order to avoid repetition. Furthermore, the terms “at least one” in connection with, for example, information, an evaluation criterion, a condition, or a cell unit are omitted.

The method begins in method step S1 with the supplying of a charging current I_L, i.e., a first defined charging current I_L1 with a first defined charging current strength at the point in time tA as the start of the charging process.

The first defined charging current I_L1 can, for example, be set as a function of a cooling of the energy supply device 1 temporally prior to the charging process. In addition or alternatively, it is possible that the first defined charging current I_L1 is set as a function of at least one of the following information: a determined state of charge of the energy supply device 1 (abbreviated to “SoC”), a determined temperature of a cell unit 11, 12; a determined ambient temperature of the energy supply device 1 and/or the charging device 2, a maximum permissible charging current strength of a cell unit 11, 12, a material configuration of the anode 11A, 12A, cathode 11K, 12K, and the electrolyte 11E, 12E of a cell unit 11, 12, a lifetime information as disclosed herein, in each case in particular before the point in time tA and/or at least at the point in time tA. The respective information can be retrieved, measured, and/or calculated as disclosed herein.

In method step S2, heat information associated with the energy supply device 1, in particular a cell unit 11, 12, and the charging device 2 is determined. The heat information W can comprise thermal loss energy or, in particular, thermal power dissipation of the energy supply device 1 and cooling capacity of the charging device 2 in relation to a defined time duration. The heat information W can be retrieved, measured, and/or calculated as disclosed herein. In other words, the heat information can represent a thermal model.

The determination of the heat information can, in particular, already be performed before or at least at the start of the charging process and thus at and/or from the point in time tA. Method step S2 can be carried out essentially simultaneously with method step S1.

In method step S3, deposition information associated with the reaction material at an anode 11A, 12A of a cell unit 11, 12 is determined. The deposition information can be determined using a simulation model and/or as a function of a characteristic map as disclosed herein. The deposition information can in particular be a calculated and/or a retrieved deposition information, for example as a function of the temperature in the energy supply device 1, the determined state of charge, the material configuration of a cell unit 11, 12, and/or a lifetime information as disclosed herein. The determined deposition information can comprise a calculated and/or retrieved degree of deposition.

The determination of the deposition information can, in particular, already be performed at the start of the charging process and thus at and/or from the point in time tA. In other words, method step S3 can be carried out essentially simultaneously with method step S1 and/or method step S2.

In method step S4, at and/or from a defined point in time, the first defined charging current I_L1 is adjusted, in particular controlled and/or regulated, to a second defined charging current I_L2 in such a way until a first evaluation criterion is fulfilled by the heat information in order to set, essentially maintain and/or not exceed a defined temperature T_red in the energy supply device 1. The first evaluation criterion comprises, in particular, a thermal condition, which comprises, for example, an equilibrium condition between the power dissipation of the energy supply device 1 and the cooling capacity of the charging device 2.

In addition or alternatively, at and/or from a defined point in time, the first defined charging current I_L1 is adjusted, in particular controlled and/or regulated, to the second defined charging current I_L2 in such a way until a second evaluation criterion is fulfilled by the deposition information in order to essentially avoid or at

least limit, in a defined manner, a deposition, in particular a plating, of the reaction material at the anode 11A, 11B of a cell unit 11, 12.

In the illustration in FIG. 5, at the defined point in time t1, the first defined charging current I_L1 is adjusted to the second defined charging current I_L2, so that a defined temperature T_red, which is essentially constant and/or at least subject to a negligible tolerance, is set within the energy supply device 1 and is essentially maintained and/or at least not exceeded for a defined time duration.

Method step S4 can be carried out essentially simultaneously with method steps S2 and/or S3 and/or with a negligible delay in each case.

In method step S5, the then new first defined charging current can be adjusted, in particular controlled and/or regulated, to a new second defined charging current I_L2 (not shown in the figures for reasons of clarity). This is illustrated in FIG. 5 by the setting of the charging current I_L at and/or from the point in time t2, wherein, in the embodiment shown, a termination of the charging process subsequently occurs at the point in time tE, in that the supply of the charging current I_L at and/or from the point in time tE is deactivated.

The method according to the present invention thus goes beyond the inclusion of a temperature in the energy supply device 1 and a state of charge of the energy supply device 1, in particular already at the start of the charging process at the point in time tA with the supply of the first defined charging current I_L1, and takes into account a deposition information, in particular in the form of lithium plating.

The charging process according to the present invention can thus be performed, for example, without a significant interruption and/or without deactivating the supply of the charging current I_L, thereby achieving an optimized, i.e., shortened charging time duration.

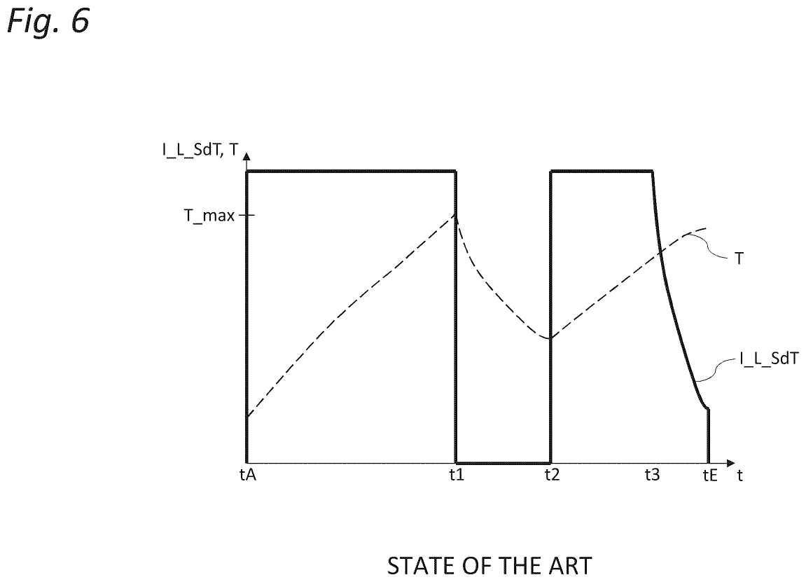

In contrast to FIG. 5, FIG. 6 shows a charging diagram of an energy supply device during a charging process according to a charging method from the prior art.

The interruption in the supply of the charging current I_L_SdT from the point in time t1 to the point in time t2 as a result of a prior increase in temperature in the energy supply device to a limit temperature T_max associated with the supply of the charging current I_L_SdT is clearly visible. In other words, a charging pause must occur for the time period between points in time t2 and t3, which leads to an extension of the charging time duration of the charging process until the point in time tE.

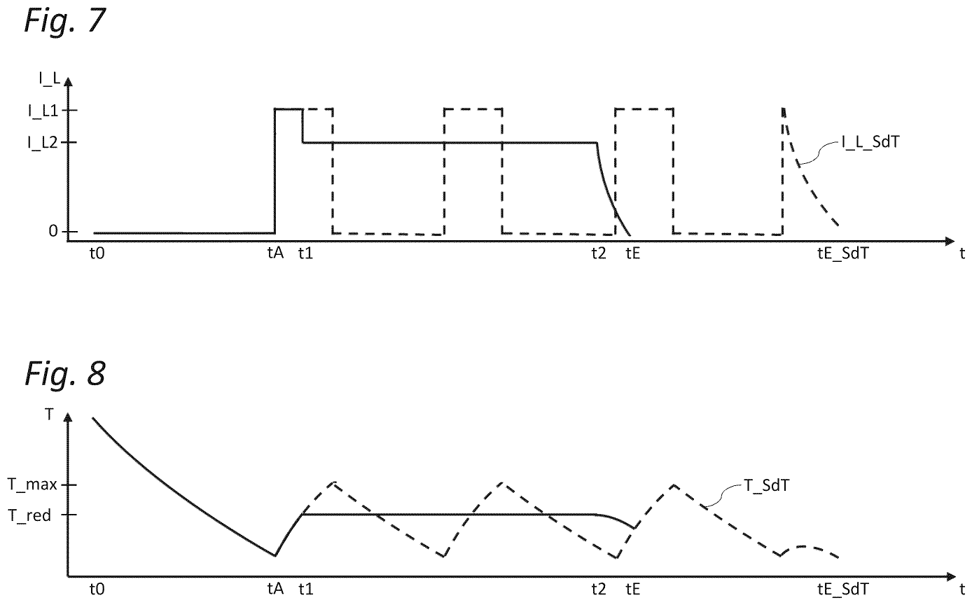

For further illustration, FIG. 7 shows a charging diagram of the energy supply device 1 during a charging process according to the first embodiment of the method according to the present invention and according to a charging method from the prior art.

In the method according to the invention, the charging current I_L can be adjusted in such a way that, for example, interruptions in the supply of the charging current I_L can be avoided. In the charging method according to the prior art, recurring interruptions in relation to the charging current I_L_SdT are always necessary, which leads at the end of the charging process at the point in time tE_SdT to a longer charging time duration. With the method according to the present invention, a charging process of the energy supply device 1 can be carried out, for example, even if the energy supply device 1 was immediately previously subjected to a discharging process and is therefore still characterized by an elevated temperature before the charging process.

FIG. 8 additionally shows a temperature curve in the energy supply device 1 during a charging process according to the first embodiment of the method according to the present invention and a temperature curve T_SdT according to a charging method according to the prior art.

The start of the charging process at the point in time tA is clearly visible, temporally preceded by a cooling phase and thus a reduction of the temperature in the energy supply device, for example from the point in time t0 onwards.

With the charging method according to the present invention, it is possible to avoid reaching and/or exceeding a limit temperature T_max in the energy supply device 1 as a result of an adjustment of the charging current I_L. The charging current I_L can be adjusted, in particular reduced in a defined manner, at least as a function of a thermal condition and/or an electrochemical condition as disclosed herein, in order to set, essentially maintain, and/or not exceed a defined temperature T_red in the energy supply device 1, and/or to essentially prevent or at least limit, in a defined manner, a deposition, in particular a plating, of the reaction material at the anode 11A, 12A.

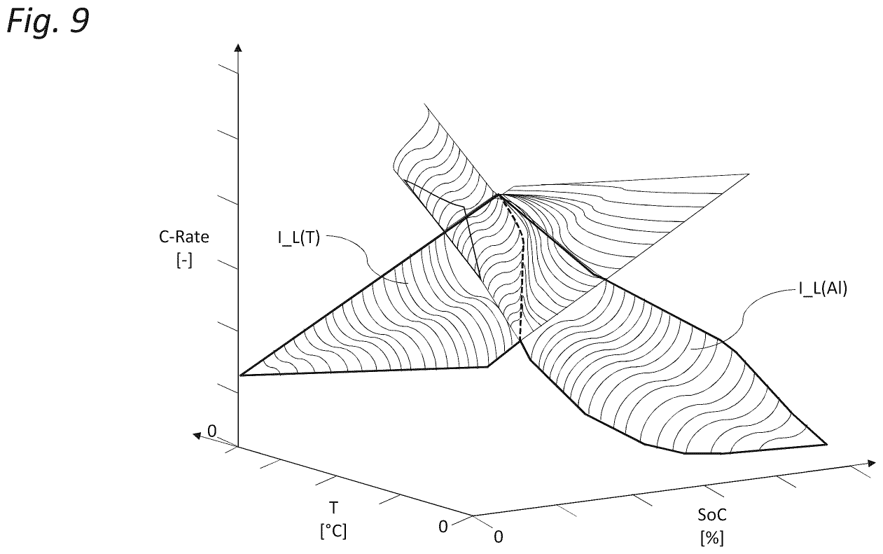

FIG. 9 shows a graphical representation of a characteristic map for the application of an embodiment of the method according to the present invention for illustrative purposes.

The charging current I_L can be set based on or as a function of characteristic map information, which comprises heat information (T) on the one hand and deposition information (Al) on the other.

In other words, the charging current I_L, i.e., the adjustment of the charging current I_L, can be performed as function on at least two information that are independent of each other, namely based on a thermal model and/or based on a deposition model.

The defined temperature of the energy supply device 1 can be set as a function of a temperature limitation condition at least by means of a regulation, in which an actual temperature is recorded, in particular measured, and compared with a target temperature. This can be performed, for example, without a simulation model.

In particular, a charging current I_L can be set at a determined temperature and a determined state of charge as a function of the evaluation criterion in such a way that it is always adjusted to the lower charging current I_L in order to realize the desired temperature effect and/or deposition effect as disclosed herein (see also the dashed line shown in FIG. 9 between the characteristic map information I_L(T) and I_L(Al), as a boundary line at which the characteristic map information for temperature T and deposition Al contains the same charging current value.

It is, of course, possible to carry out the method of the present invention with the aid of an extended, multidimensional characteristic map, which, for example, comprises associated lifetime information as disclosed herein.

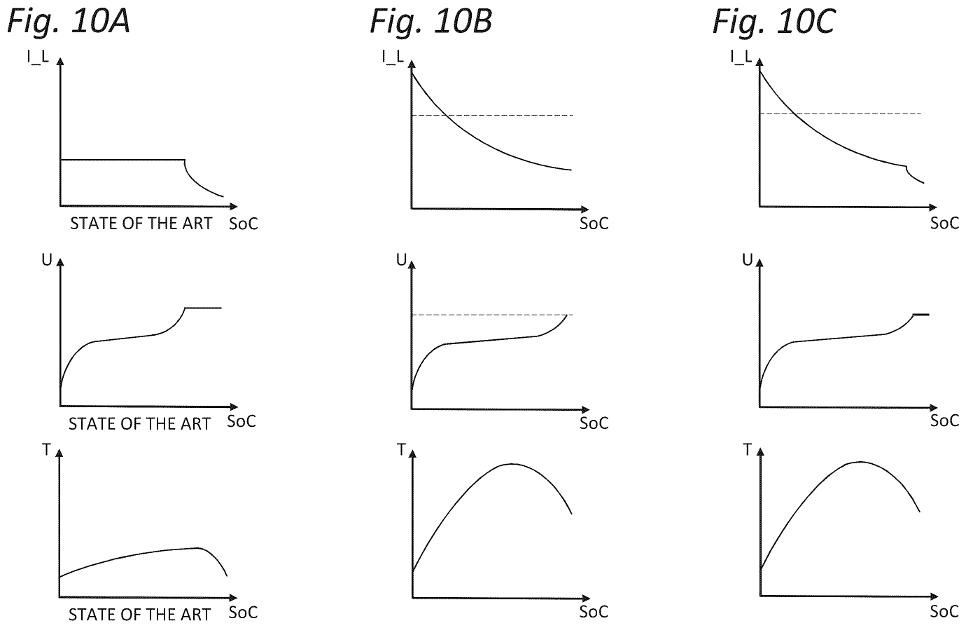

FIG. 10A shows charging diagrams of an energy supply device according to a charging method from the prior art. FIG. 10B shows charging diagrams of an energy supply device according to a second embodiment of the method according to the present invention, and FIG. 10C shows charging diagrams of an energy supply device according to a third embodiment of the method according to the present invention.

FIG. 10A shows the respective curves of the charging current I_L, the charging voltage U, and the resulting temperature in the energy supply device over the state of charge according to the constant current/constant voltage charging method (abbreviated “CC/CV”) as a known charging method. The charging process begins with a constant current phase (CC), in which the energy supply device is charged with an almost constant charging current strength until a defined voltage, for example 4.2 volts per cell unit, is reached. The defined voltage of 4.2 volts is also referred to as the cut-off voltage. This is followed by a change to the constant voltage phase (CV), in which the charging voltage is kept almost constant and the current strength of the charging current gradually decreases.

FIG. 10B shows the respective curves or profiles during the charging process based on the consideration of the deposition information (“plating model”).

In FIG. 10C, a subsequent constant-voltage charging phase is recognizable in the curves or profiles based on the consideration of the deposition information, in order not to exceed a maximum voltage of the cell units.

Looking at FIGS. 10A, 10B, and 10C as a whole, it can be seen that the charging method according to the present invention can be operated with a significantly higher and subsequently adjusted charging current I_L at the start of the charging method than with charging methods known from the prior art.

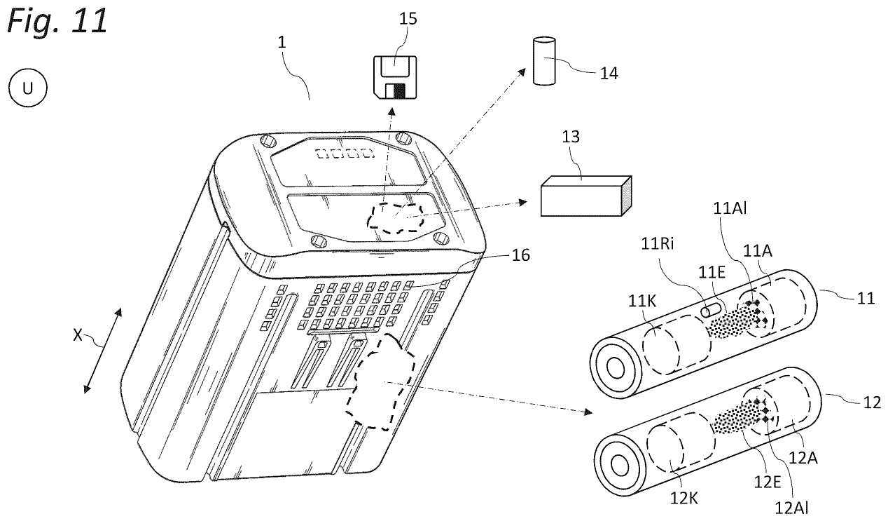

The another embodiment is illustrated in FIGS. 11-19. FIG. 11 shows the embodiment of the energy supply device 1 according to the present invention in a perspective view, wherein some units of the energy supply device 1 are shown individually highlighted.

The energy supply device 1 is a separate and/or independent device 1 for storing electrical energy and/or for delivering electrical energy. The energy supply device 1 is configured as an electrical energy source for an electric tool 3 to supply electrical energy to the electric tool 3.

The electric tool 3 can be a mobile, portable, manually operated, self-sufficient (mains-independent) and/or motor-driven electric tool 3.

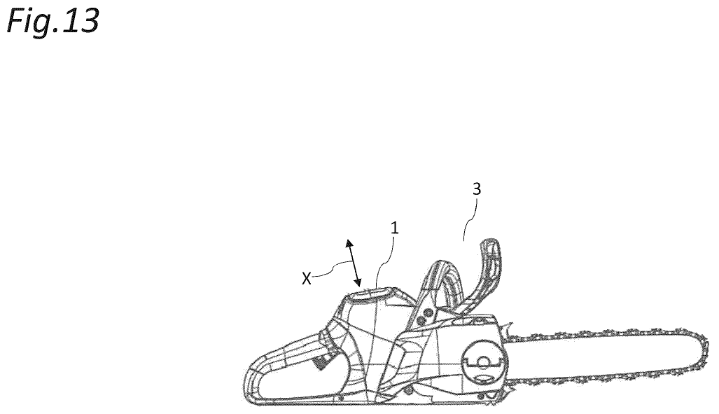

FIG. 13 shows an example of an electric tool 3 in the form of an electric motor-operated chainsaw 3 for illustrative purposes. The energy supply device 1 is exchangeably accommodated in a compartment of the electric tool 3, in particular by means of an installation process in the form of an insertion process in an installation direction X.

The energy supply device 1 is formed as a portable, manually tool-free mountable and demountable, and/or exchangeable battery pack 1. The energy supply device 1 is formed as an electrical energy supply device 1 that can be charged and discharged and can comprise a single cell unit or a plurality of cell units, of which cell unit 11 and cell unit 12 are highlighted in FIG. 11 for closer illustration.

The energy supply device 1 comprises a charging management unit 13, which is configured in particular for monitoring a charging process and/or a discharging process. The charging management unit 13 is configured, for example, during a charging process, for distributing, in particular for controlling and/or regulating, a supplied charging current to the cell unit 11, 12, in particular to the plurality of cell units 11, 12. In addition, the charging management unit 13 is configured during a discharging process to draw, in particular to control and/or regulate, a discharging current (stored charging current) from the cell unit 11, 12, in particular from the plurality of cell units 11, 12.

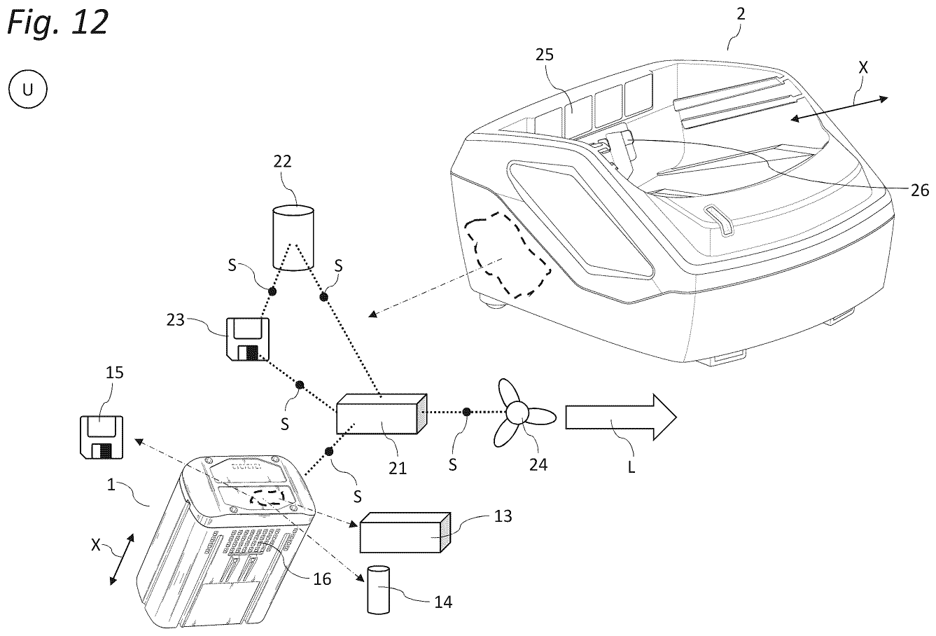

The charging management unit 13 can be configured by hardware and/or by software to realize functions in connection with a charging process and/or a discharging process in accordance with its intended purpose. The charging management unit 13 is further configured in particular to establish a communication connection with a charging device 2 by means of at least one signal S (see FIG. 12). The at least one signal S is in particular an electrically and/or electronically processable signal S. The at least one signal S comprises at least one information and/or is associated with at least one information. The charging management unit 13 can, for example, comprise a computing unit with at least one computing core, which is configured to carry out at least one algorithm of a computer program for a charging process. The at least one algorithm is in particular configured as processable and/or executable computer program code.

The energy supply device 1 can be formed as an energy supply device known from the prior art. Each or at least one cell unit 11, 12 of the plurality of cell units 11, 12 comprises, in particular, an anode 11A, 12A and a cathode 11K, 12K as well as an electrolyte 11E, 12E. The respective anode 11A, 12A, cathode 11K, 12K, and electrolyte 11E, 12E can be formed from corresponding materials or combinations of materials in order to realize electrochemical storage of electrical energy and withdrawal of stored electrical energy.

Furthermore, FIG. 11 shows a respective deposit 11Al on the anode 11A of the cell unit 11 and a deposit 12Al on the anode 12A of the cell unit 12, which are intended to illustrate the deposition of a reaction material, for example lithium. With regard to an internal resistance that characterizes the cell units 11, 12, the internal resistance 11Ri is shown symbolically and/or schematically in FIG. 11. The internal resistance 11Ri is also referred to as impedance and represents a measure of the resistance that the current flow experiences within the respective cell unit 11, 12. The internal resistance 11Ri significantly influences the performance and efficiency of the cell unit 11, 12. In other words, the internal resistance 11Ri is a parameter for assessing the condition and performance of the cell unit 11, 12 and therefore represents lifetime information.

Each or at least one cell unit 11, 12 of the energy supply device 1 can be formed, for example, on the basis of one of the following electrical storage technologies: lithium-ion technology, lithium-polymer technology, lithium-metal technology (e.g., lithium-manganese technology), lithium-iron-phosphate technology, lithium-titanate technology, sodium-ion technology. It is possible that each or at least one cell unit 11, 12 of the energy supply device 1 comprises a liquid or solid electrolyte 11E, 12E.

The at least one cell unit 11, 12 can be characterized by a cell format in the form of a round cell or a pouch cell. It is also possible that the at least one cell unit 11, 12 is formed prismatic or cubic.

It is understood that each cell unit 11, 12 comprises further elements and/or is characterized by further elements, for example a housing, at least one sealing element, etc. However, for reasons of clarity, the further elements are not shown and/or labelled.

Cell units 11, 12 of a defined number of the plurality of cell units 11, 12 can each be combined into modules. Cell units 11, 12 or respective modules with several cell units 11, 12 can be arranged partly in a series connection and/or partly in a parallel connection to realize a respective configuration of the energy supply device 1. The entirety of the cell units 11, 12 can represent the so-called core pack of the energy supply device 1.

The energy supply device 1 comprises at least one sensor unit 14 for recording, in particular measuring, at least one information associated with the energy supply device 1 and/or the charging device 2. The at least one sensor unit 14 can be formed as a separate individual unit 14. Alternatively, the at least one sensor unit 14 can be part of the charging management unit 13 and/or integrated into the charging management unit 13.

The energy supply device 1 further comprises a memory unit 15 for permanent and/or volatile saving of at least one information associated with the energy supply device 1 and/or the charging device 2.

Furthermore, the energy supply device 1 comprises at least one channel 16. The channel 16 serves to remove heat generated during a charging process in the cell units 11, 12 by means of an air flow. The channel 16 can be part of an active cooling system between the energy supply device 1 and the charging device 2. The channel 16 can be connected to several air passage openings in a flow-mechanical manner, wherein at least one air passage opening is formed as an air inlet opening in relation to a housing of the energy supply device 1 and wherein at least one further air passage opening is formed as an air outlet opening.

In an alternative embodiment of the energy supply device 1, the energy supply device 1 is channel-free. In other words, the energy supply device 1 can be formed

without air passage openings. The energy supply device 1 and/or the charging device 2 can each be characterized by a passive cooling system, wherein generated heat is transferred and/or removed to an environment U via respective housing walls and surfaces.

It is understood that the energy supply device 1 comprises further units and/or elements, and/or is characterized by further units and/or elements, for example a housing, a display unit, and/or at least one contact element for forming an electrical or electromagnetic connection with a contact element 26 of a charging device 2 assigned as a counter contact element. Further units and/or elements are hidden, are not visible, and/or are not marked for reasons of clarity.

The charging management unit 13 can, in particular, be configured for calculating the at least one charging profile information as disclosed herein. The charging profile model as disclosed herein can be saved in the memory unit 15.

FIG. 12 shows a system with the energy supply device 1 from FIG. 11 and with another embodiment of a charging device 2 according to the present invention in a perspective view. The units 13, 14, and 15 of the energy supply device 1, as well as some units of the charging device 2, are shown individually highlighted.

The charging device 2 is configured for charging and/or discharging the energy supply device 1. Charging and/or discharging is carried out in an assembly state between the energy supply device 1 and the charging device 2, in which an electrical and a mechanical connection is formed.

The charging device 2 comprises the at least one contact element 26 as a counter-contact element to a contact element of the energy supply device 1, which is associated with it, for transmitting the electrical energy during charging and/or discharging. It is understood that in addition to the at least one contact element 26 as a load contact element, the charging device 2 comprises at least one further contact element as a signal contact element for transmitting electrical signals S between the charging device 2 and an assembled, i.e., plugged-in, energy supply device 1.

In addition, the charging device 2 comprises a charging control unit 21. The charging control unit 21 is configured to provide, in particular to control and/or regulate, a charging current to the energy supply device 1 and/or to draw a discharging current during a charging process. The charging control unit 21 can, for example, comprise a computing unit with at least one computing core, which is configured to carry out at least one algorithm of a computer program for a charging process. The at least one algorithm is in particular configured as processable and/or executable computer program code.

To cool the cell units 11, 12 of the energy supply device 1 during a charging process, in particular during a fast charging process, the charging device 2 comprises a fan unit 24 for generating an air flow with air from an environment U of the charging device 2 as a cooling medium in order to apply the generated air flow to the channel 16 of the energy supply device 1. For this purpose, the charging device 2 comprises at least one duct 25 through which a generated air flow passes and/or exits and, in

the assembly state of the energy supply device 1, enters the channel 16 via at least one passage opening of the energy supply device 1 in order to flow through it, absorb generated heat, and transport it away.

The charging control unit 21 is configured to set the fan unit 24, in particular as a function of at least one operating information, in order to vary and thus adapt an air flow. In particular, the charging control unit 21 is configured to control and/or regulate the fan unit 24 in order, for example, to realize a defined volume flow (flow rate), a defined idealized and/or resulting overpressure, and/or a defined idealized and/or resulting flow velocity of the air flow.

Alternatively or additionally, the charging management unit 13 of the energy supply device 1 can be configured to set the fan unit 24, in particular as a function of at

least one operating information. It is also possible that the energy supply device 1 comprises a fan unit 24 as disclosed herein. The fan unit 24 can be integrated into a housing of the energy supply device 1.

The charging device 2 comprises at least one sensor unit 22 for recording, in particular measuring, an information associated with the energy supply device 1 and/or the charging device 2. The at least one sensor unit 22 can be formed as a separate individual unit 22. Alternatively, the at least one sensor unit 22 can be part of the charging control unit 21 and/or integrated into the charging control unit 21. The at least one sensor unit 22 can be configured to record at least one temperature, one pressure, and/or one speed of the air flow.

The charging device 2 further comprises a memory unit 23 for permanent and/or volatile saving of at least one information associated with the energy supply device 1 and/or the charging device 2, in particular temporally before, during, and/or after a charging process. The memory unit 23 can be configured analogously to the memory unit 15 and vice versa.

It is understood that the charging device 2 comprises further units and/or elements, and/or is characterized by further units and/or elements, for example a housing, a converter unit with a transformer and a rectifier for converting alternating current into direct current, and/or a display unit for outputting a status of the energy supply device 1 and/or the charging device 2. Further units and/or elements are hidden, are not visible, and/or are not marked for reasons of clarity. The charging device 2 can be configured as a charging device known from the prior art.

The charging control unit 21 can be configured in particular for calculating the at least one charging profile information as disclosed herein. The charging profile model as disclosed herein can be saved in the memory unit 23.

The charging management unit 13 and/or the charging control unit 21 are each configured to process at least one information as disclosed herein, in particular by means of at least one algorithm of a computer program for a charging process. The at least one algorithm is in particular configured as processable and/or executable computer program code.

The energy supply device 1 and the charging device 2 are configured in particular to carry out the method disclosed herein, wherein a charging method can be realized

at comparatively deep (low) temperatures.

The method according to the invention is characterized in particular by the fact that a time duration for the charging process can be minimized by at least one discharging phase, while at the same time aging effects and, in particular, deposition effects are essentially avoided.

The present invention is described below with reference to the method and by means of embodiments in which the cell units 11, 12 of the energy supply device 1 can be formed, for example, on the basis of lithium-ion storage technology.

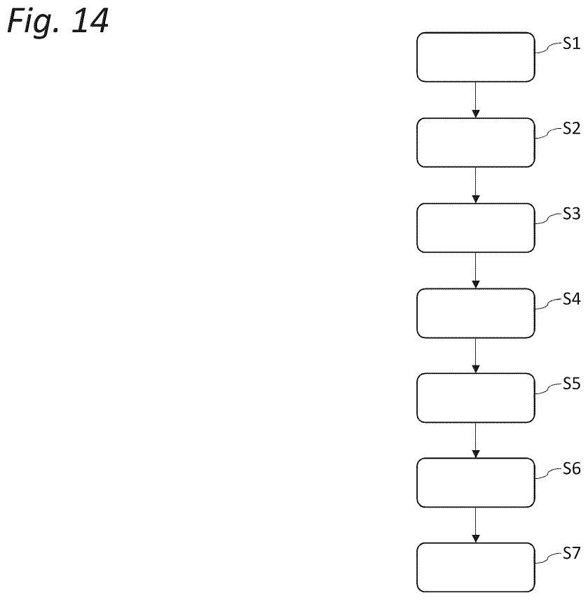

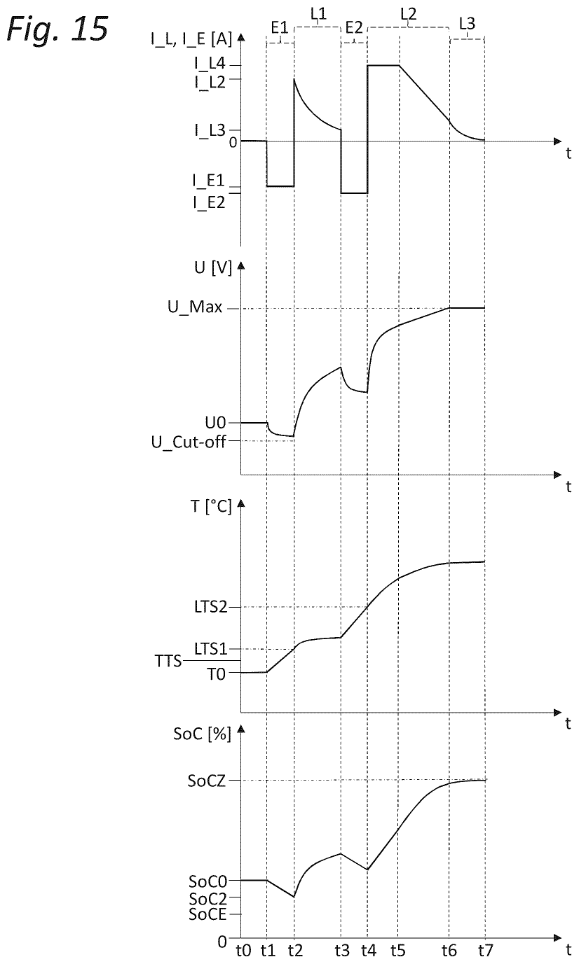

FIG. 14 shows a flowchart of another embodiment of the method according to the present invention. FIG. 15 shows several associated charging diagrams in schematic illustration, in which a temporal curve of a charging current I_L, a discharging current I_E, a charging voltage U, a temperature T, and a state of charge SoC (abbreviation “SoC” for “state of charge”) is shown.

The method steps of the method are described in the following, with only partial reference to devices, units, and/or elements in order to avoid repetition. Furthermore, the terms “at least one,” for example in connection with information or a cell unit, are omitted.

The method relates to a charging process of the energy supply device 1 as disclosed herein. The charging process can be divided into several phases based on points in time and/or time durations, wherein at least one charging phase L1, L2 for supplying a charging current I_L2, I_L3, I_L4 to the energy supply device 1, i.e., to the cell unit 11, 12, and at least one discharging phase E1, E2 for drawing a discharging current I_E1, I_E2 from the energy supply device 1, i.e., from the cell unit 11, 12, are comprised.

The energy supply device 1 and thus the cell unit 11, 12 can be in a state at a point in time t0 which is characterized by a comparatively deep (low) temperature T0 and/or a comparatively low state of charge SoC0. Furthermore, the energy supply device 1 and, in particular, the cell unit 11, 12 can be characterized by a voltage U0 at the point in time t0.

The temperature T0 can, for example, be determined by an environment U in which the energy supply device 1 with a charging device 2 is located (see FIGS. 11 and 12). The temperature T0 can, for example, be less than approximately 0 degrees Celsius and thus less than a defined low temperature threshold value TTS. The defined low temperature threshold value TTS can, for example, be approximately 10 degrees Celsius, for example depending on the configuration of the energy supply device 1. The state of charge SoC0 is at least greater than 0 percent at the point in time t0 and, in particular, greater than a state-of-discharge threshold value SoCE.

At such a deep temperature T0, the internal resistance 11Ri of the cell unit 11, 12 can be increased and there is a possibility of deposition 11Al, 12Al of a reaction material, for example in the form of lithium, at the anode 11, 12 if a charging process is carried out according to a conventional charging method for charging the energy supply device 1.

The method can begin in method step S1 with the provision of a target state-of-charge information. The target state-of-charge information can be a target state-of-charge information defined by a user and/or defined by the charging management unit 13 and can comprise, for example, a target state of charge SoCZ of the energy supply device, for example approximately 80 percent, and/or a maximum time duration for the charging process, for example approximately 90 minutes. A target state of charge SoCZ of approximately 80 percent means that the energy supply device 1 is to be charged to 80 percent of its (maximum) capacity.

In method step S2, the temperature T0 and the state of charge SoC0 at the point in time t0 are determined, which are each associated with the energy supply device 1, i.e., the cell unit 11, 12.

The determination of the temperature T0 can be carried out by retrieving, measuring and/or calculating the temperature T0 and/or a change in the temperature T0 at the start of the charging process, i.e. at the point in time t0, and thus temporally before a charging phase L1, L2, L3 and/or temporally before a discharging phase E1, E2.

The determination of the state of charge SoC0 can be carried out by retrieving, measuring and/or calculating the state of charge SoC0 and/or a change in the state of charge SoC0 at the start of the charging process, i.e. at the point in time t0, and thus temporally before a discharging phase E1, E2 and/or temporally before a charging phase L1, L2, L3.

It is understood that the temperature T and/or the state of charge SoC are determined during the further course of the charging process, in particular multiple times, in order to carry out the charging process in accordance with the method.

In method step S3, a charging profile information is calculated as a function of the determined temperature T0, the determined state of charge SoC0, and the target state-of-charge information using a charging profile model with a model information for setting, in particular regulating and/or controlling, a charging and/or a discharging of the energy supply device 1.

The charging profile model can be configured as disclosed herein. The charging profile information can be configured as disclosed herein. The charging profile information can comprise a first minimum and/or maximum time duration for the charging process, which is calculated at the point in time t0. The charging profile information can comprise a first estimated time duration for the charging process at the point in time t0. The model information can be configured as disclosed herein and can comprise, in particular, a deposition information. The deposition information can be saved in a characteristic map and provide deposition-specific characteristic map information associated with the energy supply device 1 and thus to the cell unit 11, 12. The model information can additionally or alternatively comprise a deposition information calculated by a charging process simulation model.

The time duration between the points in time t0 and t1 therefore comprises the provision of information, a detection and/or a calculation in relation to the charging process.

In dependence on the calculated charging profile information, in method step S4, at the point in time t1 and/or from the point in time t1 onward, the discharging phase E1 takes place with a drawing of the discharging current I_E1 from the energy supply device 1 for a defined discharging time duration up to the point in time t2.

If the state of charge SoC0 at the point in time t0 would lie already below the state-of-discharge threshold value SoCE, a charging phase L1 can alternatively be performed at the point in time t1 and/or from the point in time t1 onwards, with a charging current I_L1 being supplied to the energy supply device 1 for a defined charging time duration.

The discharging phase E1 is accompanied by an increase in temperature T until at least a first charging temperature threshold value LTS1 is reached at the point in time t2. The discharging current I_E1 for the discharging phase E1 and/or a discharging time duration for the discharging phase E1 is set such that a voltage U of the energy supply device 1 does not fall below at least the cut-off voltage limit value U_Cut-off, thereby preventing deep discharge, for example.

In addition or alternatively, the discharging current I_E1 for the discharging phase E1 and/or a discharging time duration for the discharging phase E1 is set such that a state of charge SoC during the discharging phase E1 and/or a state of charge SoC2 at the end or towards the end of the discharging phase E1 at point in time t2 does not fall below at least one deep state-of-charge limit value, which is accompanied by a respective voltage of the cell unit 11, 12, which can lie, for example, in a range between approximately 2.0 volts and approximately 2.5 volts, depending on the configuration of the cell unit 11, 12.

The illustration in FIG. 15 clearly shows that a significant increase in temperature can be realized in the energy supply device 1 during the discharging phase E1.

In method step S5, at the point in time t2 and/or from the point in time t2 onwards, the charging phase L1 takes place with a supplying of the charging current I_L2 for a defined charging time duration up to the point in time t3. From the profile curve of the charging current I_L, it can be seen that the charging current I_2 initially supplied during the charging phase L1 decreases to the charging current I_L3 at the point in time t3 during the charging time duration of the charging phase L1. At the same time, during the charging phase L1, the state of charge SoC and the temperature T continue to increase.

With the charging phase L1, starting from the temperature, which essentially corresponds to the first temperature threshold value LTS1, a further increase in the temperature takes place during charging phase L1 as a result of supplying the charging current I_L2 at the point in time t2 and/or from the point in time t2 up to the point in time t3.

Supplying the charging current I_L, I_L2, I_L3 during the charging phase L1 as a function of the charging profile information is performed in such a way that, in particular, a deposition of the reaction material in the cell unit 11, 12 is essentially avoided or at least limited in a defined manner.

The further increase in temperature T during charging phase L1 can be rather moderate compared to the temporally preceding discharging phase E1 between the points in time t1 and t2.

Supplying the charging current I_L, I_l2, I_L3 during the charging phase L1 as a function of the charging profile information can additionally be carried out as a function of a lifetime information based on the charging profile information.

The charging phase L1 can be carried out as a function of the charging profile model as disclosed herein. For example, it is possible that during the charging phase L1, the charging current I_L can be set dynamically and thus variably.

In method step S6, at the point in time t3 and/or from the point in time t3 onwards, the discharging phase E2 takes place and thus a further, second discharging phase E2 with a drawing of the discharging current I_E2 from the energy supply device 1 for a defined discharging time duration up to the point in time t4 in order to further increase the temperature T in the energy supply device 1 until at least a second charging temperature threshold value LTS2 is reached.

The discharging phase E2 can then take place, for example, if the discharging current I_L is set comparatively low during the charging phase L1, for example due to an increase in the voltage U, and, for example, the temperature T in the energy supply device 1 has not yet reached and/or exceeded the second charging temperature threshold value LTS2.

As soon as the temperature in the energy supply device 1 reaches the second charging temperature threshold value LTS2, a further charging phase L2 takes place in process step S7 at the point in time t4 and/or from the point in time t4 with a supply of the charging current I_L4 for a defined charging time duration up to the point in time t5.

From the profile curve of the charging current I_L, it can be seen for the further charging phase L2 that the charging current I_4 is essentially constant during the charging time duration of the charging phase L2 up to the point in time t5 and decreases from the point in time t5 up to the point in time t6. In other words, the charging phase L2 temporarily comprises a constant charging current phase up to the point in time t5. The charging current I_L can be a maximum charging current I_L, which is accompanied by a further increase in temperature T, in particular a disproportionate increase in temperature T.

Supplying, in particular adjusting, the charging current I_L between the points in time t5 and t6 is carried out in particular as a function of the charging profile information. The charging phase L2 is characterized by the supply of a temporarily essentially constant charging current I_L with a subsequent decreasing charging current I_L.

At the point in time t6, the energy supply device 1 is in a state, due to a further increase in the temperature T and voltage U, such that at the point in time t6 and/or from the point in time t6 onward, a charging phase L3 is carried out with supplying a charging current I_L in such a manner that a reached maximum charging voltage U_Max (cut-off voltage) remains essentially constant during the charging phase L3 and/or is at least not exceeded. In other words, the charging phase L3 represents a so-called constant voltage charging phase (abbreviated “CV phase”).

At the point in time t7, the defined target state of charge SoCZ is essentially reached, whereby the charging process is terminated.

According to the invention, the respective charging phases L1, L2, L3 and discharging phases E1, E2 are each set as a function of the respective calculated charging profile information (especially with regard to time duration, point in time, charging current, discharging current) in order to minimize the charging process duration and/or essentially avoid or at least limit, in a defined manner, a deposition, in particular a plating, of the reaction material in the energy supply device 1, i.e., at an anode 11A, 12A of the cell unit 11, 12.

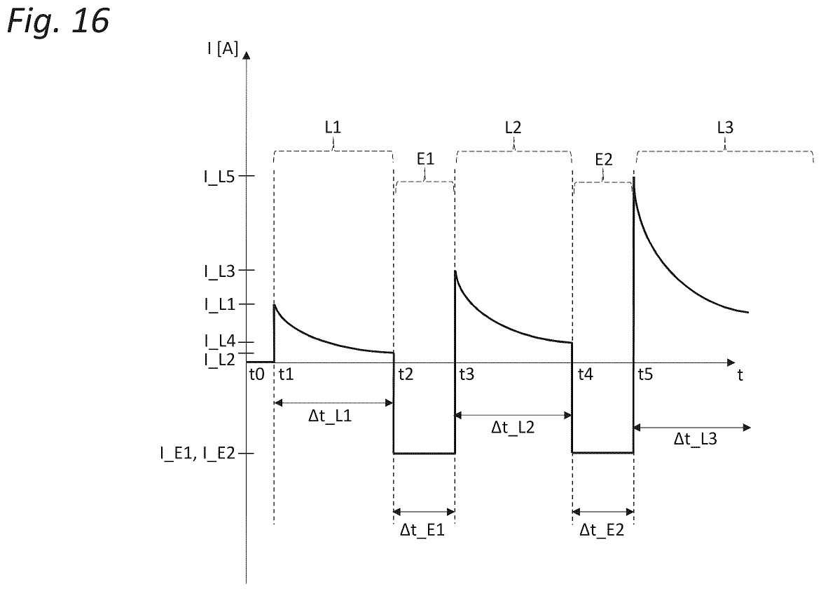

In the following, excerpts of a respective charging diagram in schematic illustration are described on the basis of the further FIGS. 16 to 19 in order to explain the method in more detail in partial aspects.

FIG. 16 shows an excerpt from a charging diagram of an energy supply device during a charging process according to a second embodiment of the method according to the invention of FIGS. 11-19. In FIG. 16, a curve of a charging current I_L1, I_L2, I_L3, I_L4, I_L5 and a discharging current I_E1, I_E2 at respective points in times t0, . . . , t5 and/or for respective time durations Δt_L1, Δt_E1, Δt_L2, Δt_E2, Δt_L3 is illustrated.

At the start of the charging process and thus at the point in time t1, a charging phase L1 with the supply of a charging current I_L1, I_L2 at the point in time t1 and/or from the point in time t1 is performed in this embodiment instead of a discharging phase E1, E2. The charging phase L1 is characterized by the charging time duration Δt_L1, which ends at the point in time t2 with the charging current I_L2.

After completion of the charging phase L1, the discharging phase E1 begins at the point in time t2 and/or is performed from the point in time t2 with the discharging time duration Δt_E1, wherein drawing a discharging current I_E1 is performed in order to further increase the temperature T in the energy supply device 1 after the charging phase L1.

The charging phase L2, which follows at the point in time t3 and/or from the point in time t3, with a charging time duration Δt_L2, is performed by supplying a larger charging current I_L3, I_L4 than during the charging phase L1.

In order to further heat the energy supply device 1, a discharging phase E2 is performed again at the point in time t4 and/or from the point in time t4, which is characterized by the discharging time duration Δt_E2 and ends at the point in time t5.

The charging phase L3, which follows at the point in time t5 and/or from the point in time t5 onwards with a charging time duration Δt_L3 is again performed with supplying a charging current I_L5, which is at least at the start of the charging phase L3 in each case greater than the charging current I_L1 and I_L3 at the start of the temporally preceding charging phases L1 and L2.

The charging current I_L can be set higher with an increasing number of charging phases L1, L2, L3 in each case to the temporally preceding charging phase L1, L2, L3, which is made possible by the increase in temperature due to intermediate discharging phases E1, E2.

The charging current I_L is set, in particular dynamically set, during the respective charging phases L1, L2, L3 as a function of the charging profile information and thus as a function of the respective deposition information in such a way that the deposition of a reaction material in the energy supply device 1, in particular at an anode 11A, 12A of the cell unit 11, 12 is essentially avoided and/or at least limited in a defined manner, while at the same time minimizing the time duration of the charging process. The charging current I_L can be set to increase in a cascade-like manner after each discharging phase E1, E2 in a subsequent charging phase L1, L2, L3, so that, despite the discharging phases E1, E2 having been carried out or performed, the overall charging time duration for the charging process is shorter.

The absolute value of the discharging current I_E1 for the discharging phase E1 can be set to at least equal to or greater than an absolute value of the charging current I_L1 for the charging phase L1. In other words, the temporally last and/or smallest value of the charging current I_L2, I_L4 of a charging phase L1, L2 in relation to a respective charging phase L1, L2 can be equal to or smaller than a largest and/or averaged value of a temporally subsequent discharging phase E1, E2.

It is possible that the charging time duration Δt_L1 of a first charging phase L1 is equal to or less than a charging time duration Δt_L2 of a second charging phase L2, which is carried out temporally subsequent to the first charging phase L1.

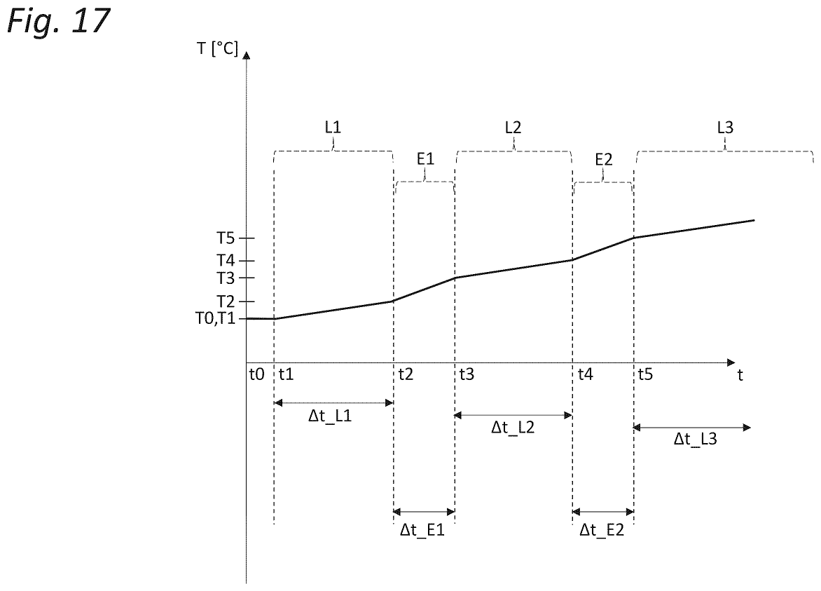

FIG. 17 additionally shows an excerpt from a further charging diagram of the charging process according to the second embodiment of the method. FIG. 17 shows a curve of the temperature T, which graphically represents the increasing rise in temperature T over time t.

The temperature T3 at the point in time t3 and the temperature T5 at the point in time t5, which are reached at the end of the respective discharging phases E1, E2, are each greater than the temperature T2 at the point in time t2 and the temperature T4 at the point in time t4 of the respective associated discharging phase E1, E2 and thus the temperature T2, T4 at the start of the respective discharging phase E1, E2.

It is possible that a temperature T3 at the end of a first discharging phase E1 is essentially equal to a temperature T5 at the end of a discharging phase E2 carried out temporally subsequent thereto.

It is furthermore evident from the illustration in FIG. 17 that, for example, a rate of change of the temperature T during the discharge phase E1 is significantly greater than during the charging phase L1 carried out temporally beforehand. The same applies to the discharging phase E2 in relation to charging phase L1.

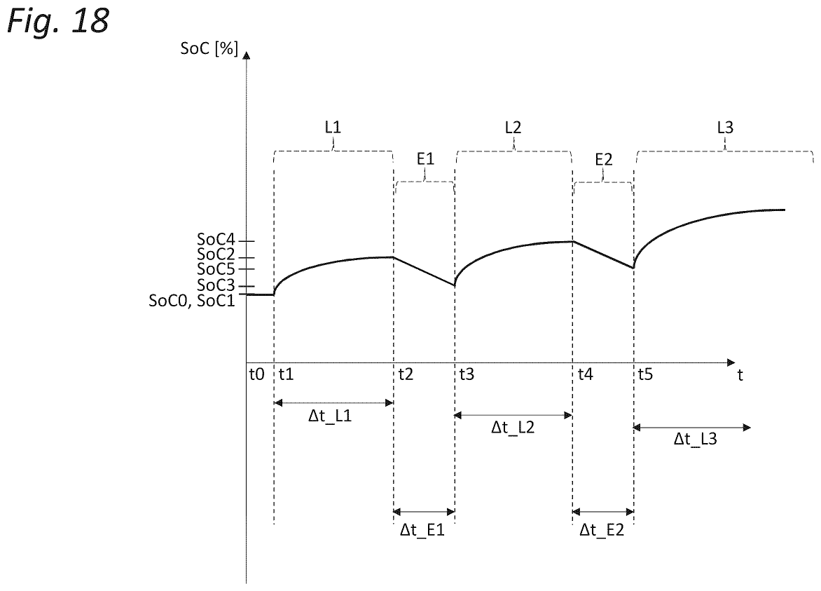

FIG. 18 shows an excerpt from a further charging diagram of the charging process according to the second embodiment of the method. FIG. 18 shows the curve of a state of charge SoC.

On the one hand, the curve of the state of charge SoC during the discharge phases E1, E2 is clearly recognizable, in which in each case a decrease to respective state of charge values occurs (SoC3 at the point in time t3 and SoC5 at the point in time t5). Furthermore, it can be recognized from the illustration in FIG. 18 that the state of charge SoC5 at the end of the discharge phase E2 at the point in time t5 is essentially equal to or, in particular, greater than the state of charge SoC3 at the end of the temporally preceding discharge phase E1 at the point in time t3.

On the other hand, with regard to the charging phases L1, L2, and L3, it can be recognized that the increase of the state of charge SoC during the respective charging time durations Δt_L1, Δt_L2, Δt_L3 becomes progressively greater with each respective charging phase L1, L2, L3.

The supply of the respective charging current I_L1, I_L2, I_L3, I_L4, I_L5 during the charging phases L1, L2, L3 can be performed as a function of a determined (temporal) rate of change of the state of charge SoC.

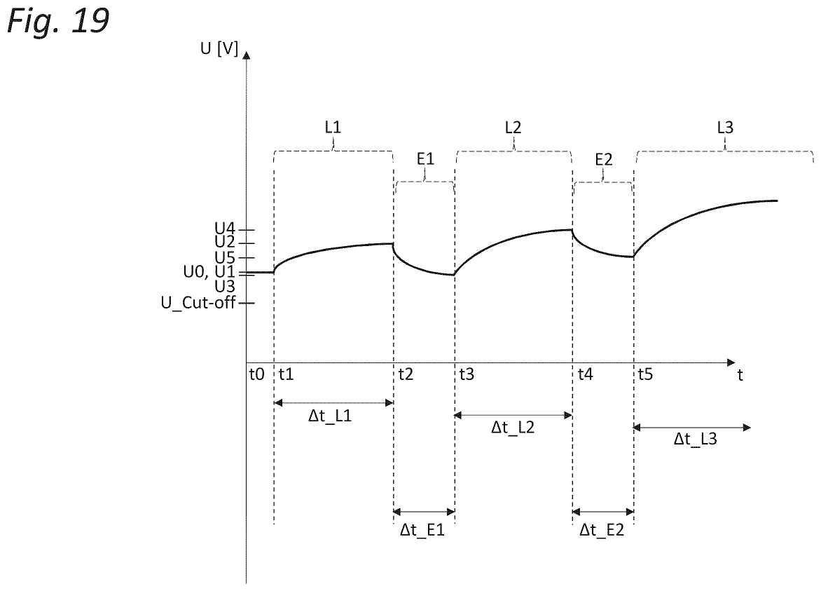

FIG. 19 shows an excerpt from a further charging diagram of the charging process according to the second embodiment of the method. In FIG. 19, a curve of a voltage U is illustrated.

In the charging method according to the present invention, from the start of the charging process at the point in time t1 onward, increasingly higher charging voltages U can be realized during the respective charging phases L1, L2, L3, in particular until a maximum charging voltage U_Max is reached (see also, additionally, FIG. 15).

The discharging phases E1, E2 can, for example, also be performed in the form of discharging pulses, which are characterized by comparatively very short discharging time durations Δt_E1, Δt_E2.

Within the scope of the present disclosure, further additional and/or modified method steps, i.e., sections and phases of the method are possible. Furthermore, it is also possible that method steps disclosed herein can be carried out at least partially temporally in parallel and/or in a temporally different sequence when carrying out the method. It is furthermore possible to correspondingly combine the further method steps disclosed herein according to the present invention, which are not mentioned in the course of the figure description.

The present invention is not limited to the embodiments described above. Rather, a variety of variants and modifications are possible which also make use of the inventive concept and therefore fall within the scope of protection. In particular, the present invention also claims protection for the subject matter and features of the dependent claims independently of the claims referred to.

### List of Reference Signs

1 energy supply device
2 charging device
3 electric tool
11 cell unit
11A anode
11Al deposit
11E electrolyte
11K cathode
11Ri internal resistance
12 cell unit
12A anode
12Al deposit
12E electrolyte
12K cathode
13 charging management unit
14 sensor unit
15 memory unit
16 channel
21 charging control unit
22 sensor unit
23 memory unit
24 fan unit
25 duct
26 contact element
I_L charging current
I_L1 charging current
I_L2 charging current
I_L_SdT charging current
S signal
SoC state of charge
t time
T temperature
T_max limit temperature
T_reddefined temperature
T_SdT temperature
L air flow
tA start point in time
tE end point in time
tE_SdT end time
W heat
X installation direction
E1 discharging phase
E2 discharging phase
I_E discharging current
I_E1, I_E2 discharging current
I_L1, . . . , I_L5 charging current
L1 charging phase
L2 charging phase
L2 charging phase
LTS1 charging temperature threshold value
LTS2 charging temperature threshold value
SoC0, . . . , SoC5 state of charge
SoCE state-of-discharge threshold value
SoCZ target state of charge
t0, . . . , t7 point in time
T0, . . . , T5 temperature
TTS low temperature threshold value
U voltage
U0, . . . , U5 voltage
U_Cut-off cut-off voltage limit value
U_Max maximum voltage
Δt_L1 charging time duration
Δt_L2 charging time duration
Δt_L3 charging time duration
Δt_E1 discharging time duration
Δt_E2 discharging time duration

1. A method for charging an energy supply device for an electric tool by means of a charging device during a charging process, wherein the energy supply device comprises a plurality of cell units,
with the following method steps:
a) determining at least one heat information associated with the energy supply device and/or the charging device;
b) determining at least one deposition information associated with a reaction material at an anode of at least one of the cell units;
c) supplying a first defined charging current to the energy supply device;
d) adjusting the first defined charging current to a second defined charging current until:
at least one first evaluation criterion, which comprises at least one thermal condition, is fulfilled by the at least one heat information in order to set, maintain and/or not exceed a defined temperature in the energy supply device; and/or
at least one second evaluation criterion, which comprises at least one electrochemical condition, is fulfilled by the at least one deposition information, in order to avoid or at least limit, in a defined manner, a deposition of the reaction material at the anode of the at least one cell unit.

2. The method according to claim 1, wherein the adjustment of the first defined charging current to the second defined charging current is performed as a function of the evaluation criterion for which the second defined charging current is smaller in each case; or
wherein the adjustment of the first defined charging current to the second defined charging current is performed at a point in time or from a point in time when reaching and/or exceeding a limit temperature in the energy supply device and/or in the charging device is determined; or
wherein the adjustment of the first defined charging current to the second defined charging current is performed as a function of at least one operating information, which comprises at least one of the following:
a reduction factor for reducing the second defined charging current by a defined proportion;
a defined tolerance range at least for the second defined charging current.

3. The method according to claim 1, wherein determining the at least one heat information comprises:
determining at least one heat loss information associated with the energy supply device; and
determining at least one charging cooling information associated with the charging device and/or the energy supply device;
wherein the at least one first evaluation criterion comprises an equilibrium condition between a power loss of the energy supply device and a cooling capacity of the charging device.

4. The method according to claim 1, comprising:
retrieving, measuring, and/or calculating at least one heating capacity or a change in at least one heating capacity associated with the energy supply device during a cooling process prior to the charging process;
retrieving, measuring, and/or calculating at least one cooling capacity or a change in at least one cooling capacity associated with the charging device during a cooling process prior to the charging process;
retrieving, measuring, and/or calculating at least one heating capacity or a change in at least one heating capacity associated with the energy supply device during the charging process; or
retrieving, measuring, and/or calculating at least one cooling capacity or a change in at least one cooling capacity associated with the charging device during the charging process;
and in each case assigning the respective at least one heating capacity to the at least one heat information or in each case assigning the respective at least one cooling capacity to the at least one heat information.

5. The method according to claim 1, comprising:
determining at least one environmental information associated with an environment of the energy supply device or an environment of the charging device;
repeating at least one of the method steps a), b), c) and/or d) in each case as a function of the at least one environmental information.

6. The method according to claim 1, comprising:
retrieving, measuring, and/or calculating at least one potential or a change in at least one potential associated with the anode of the at least one cell unit;
retrieving, measuring, and/or calculating at least one state of charge or a change in at least one state of charge associated with the energy supply device;
retrieving, measuring, and/or calculating at least one ambient temperature or a change in at least one ambient temperature associated with an environment of the energy supply device;
retrieving, measuring, and/or calculating at least one cell temperature or a change in at least one cell temperature associated with the at least one cell unit;
and in each case assigning the at least one potential, the at least one state of charge, the at least one ambient temperature, or the at least one cell temperature to the at least one deposition information.

7. The method according to claim 1, comprising:
determining at least one lifetime information associated with the energy supply device;
repeating at least one of the method steps a), b), c) and/or d) in each case as a function of the at least one lifetime information; or
determining at least one charging power information associated with the charging device;
adjusting the first defined charging current to the second defined charging current until at least one third evaluation criterion, which comprises at least one power condition, is fulfilled by the at least one charging power information in order to set, maintain and/or not exceed a maximum permissible charging power of the charging device; wherein the adjustment of the first defined charging current to the second defined charging current is performed temporally before or independently of a fulfilment of the first evaluation criterion and/or the second evaluation criterion; or
deactivating the supply of the first defined charging current or drawing a defined supplied charging current from the energy supply device until at least one evaluation criterion is fulfilled; or
setting a cooling unit of the charging device for generating a media flow for cooling the energy supply device by a charging management unit of the energy supply device until the at least one first evaluation criterion and/or at least one second evaluation criterion is fulfilled.

8. A charging device for charging an energy supply device for an electric tool during a charging process, wherein the energy supply device comprises a plurality of cell units, wherein the charging device comprises:
a cooling unit for generating a media flow for cooling the energy supply device during the charging process;
a charging control unit for establishing a communication connection with the energy supply device,
wherein the charging control unit is configured
a) for determining at least one heat information associated with the energy supply device and/or the charging device;
b) for determining at least one deposition information associated with a reaction material at an anode of at least one of the cell units;
c) for supplying a first defined charging current to the energy supply device; and
d) for adjusting the first defined charging current to a second defined charging current until
at least one first evaluation criterion, which comprises at least one thermal condition, is fulfilled by the at least one heat information, in order to set, maintain and/or not exceed a defined temperature in the energy supply device; and/or
at least one second evaluation criterion, which comprises at least one electrochemical condition, is fulfilled by the at least one deposition information, in order to avoid or at least limit, in a defined manner, a deposition of the reaction material at the anode of the at least one cell unit;
wherein the charging device is configured to carry out a method according to claim 1.

9. An energy supply device for an electric tool, which comprises a plurality of cell units and is configured for charging by means of a charging device during a charging process,
wherein the energy supply device comprises:
a charging management unit for establishing a communication connection with the charging device,
wherein the charging management unit is configured
a) for determining at least one heat information associated with the energy supply device and/or the charging device;
b) for determining at least one deposition information associated with a reaction material at an anode of at least one of the cell units;
c) for supplying a first defined charging current to the energy supply device; and
d) for adjusting the first defined charging current to a second defined charging current until
at least one first evaluation criterion, which comprises at least one thermal condition, is fulfilled by the at least one heat information, in order to set, maintain and/or not exceed a defined temperature in the energy supply device; and/or
at least one second evaluation criterion, which comprises at least one electrochemical condition, is fulfilled by the at least one deposition information, in order to avoid or at least limit, in a defined manner, a deposition of the reaction material at the anode of the at least one cell unit;
wherein the energy supply device is configured to carry out a method according to claim 1.

10. (canceled)

11. A method for charging an energy supply device for an electric tool by means of a charging device during a charging process, wherein the energy supply device comprises at least one cell unit,
with the following method steps:
a) determining at least one temperature and at least one state of charge, wherein the at least one temperature and the at least one state of charge are each associated with the energy supply device;
b) calculating at least one charging profile information as a function of the at least one temperature, the at least one state of charge and at least one target state-of-charge information using a charging profile model with at least one model information for setting a charging and/or a discharging of the energy supply device, wherein the at least one charging profile information comprises a charging process duration associated with the charging process, and wherein the at least one model information comprises a deposition information associated with a reaction material of the energy supply device;
c) drawing a discharging current from the energy supply device during at least one discharging phase, and
d) supplying a charging current to the energy supply device during at least one charging phase,
in each case as a function of the calculated at least one charging profile information, in order to minimize the charging process duration or to avoid or at least limit, in a defined manner, a deposition of the reaction material in the energy supply device.

12. The method according to claim 11, wherein the at least one discharging phase is carried out before the at least one charging phase if the determined at least one temperature is less than or at least equal to a defined low temperature threshold value, and/or if the determined at least one state of charge is greater than 0 percent or greater than a defined state-of-discharge threshold value,
in each case to heat the energy supply device until a temperature of the energy supply device reaches or exceeds at least a first charging temperature threshold value.

13. The method according to claim 11, wherein the discharging current for the at least one discharging phase and/or a discharging time duration for the at least one discharging phase is set in each case such that a voltage of the energy supply device does not fall below at least one cut-off voltage limit value; or
wherein the discharging current for the at least one discharging phase and/or a discharging time duration for the at least one discharging phase is set in each case such that a state of charge of the energy supply device does not fall below at least one deep state-of-charge limit value; or
wherein a discharging time duration is set for the at least one discharging phase, which is shorter than a charging time duration for the at least one charging phase; or
wherein an absolute value of the discharging current for the at least one discharging phase is set to be greater than an absolute value of the charging current for the at least one charging phase.

14. The method according to claim 11, wherein the charging current for at least one second charging phase, which follows at least one first charging phase and at least one discharging phase, is set to be at least in sections equal to or greater than the charging current for the at least one first charging phase; or
wherein the discharging current for at least one second discharging phase, which follows at least one first discharging phase and at least one charging phase, is set such that a state of charge after the at least one second discharging phase is equal to or greater than a state of charge after the at least one first discharging phase; or
wherein, after a first discharging phase and after a charging phase, a second discharging phase is performed if, by supplying the charging current during the charging phase, a temperature of the energy supply device lies below at least one second charging temperature threshold value, in order to heat the energy supply device, until the temperature of the energy supply device reaches or exceeds the at least one second charging temperature threshold value.

15. The method according to claim 11, comprising:
deactivating the withdrawal of the discharging current if a temperature of the energy supply device reaches or exceeds at least one second charging temperature threshold value; or
determining at least one lifetime information associated with the energy supply device;
calculating the at least one charging profile information as a function of the determined at least one lifetime information.

16. The method according to claim 15, comprising:
retrieving, measuring, and/or calculating at least one internal resistance or a change in at least one internal resistance associated with the energy supply device;
retrieving, measuring, and/or calculating at least one capacity or a change in at least one capacity associated with the energy supply device;
retrieving, measuring, and/or calculating at least one cumulative charging energy or a change in at least one cumulative charging energy associated with the energy supply device; or
retrieving, measuring, and/or calculating at least one charging process number or a change in at least one charging process number associated with the energy supply device;
and in each case assigning the at least one internal resistance, the at least one capacitance, the at least one cumulative charging energy and/or the at least one charging process number to the at least one lifetime information.

17. The method according to claim 11, comprising:
retrieving, measuring, and/or calculating at least one ambient temperature or
a change in at least one ambient temperature associated with an environment of the energy supply device;
calculating the at least one charging profile information as a function of the retrieved, measured, and/or calculated at least one ambient temperature.

18. The method according to claim 11, comprising:
transmitting the withdrawn discharging current to at least one further cell unit of the energy supply device or to at least one further energy supply device with at least one cell unit as a function of at least one temperature of the at least one further energy supply device and/or an ambient temperature associated with an environment of the at least one further energy supply device.

19. A charging device for charging an energy supply device for an electric tool during a charging process, wherein the energy supply device comprises at least one cell unit,
wherein the charging device is configured to carry out a method according to claim 11.

20. An energy supply device for an electric tool, which comprises at least one cell unit and is configured for charging by means of a charging device during a charging process,
wherein the energy supply device is configured to carry out a method according to claim 11.
